(19) United States
(12) Patent Application Publication
(10) Pub. No.: US 2026/0338692 A1
(43) Pub. Date: Oct. 29, 2026

(54) SAMPLE MEASURING DEVICE, CONTROL METHOD FOR SAMPLE MEASURING DEVICE, AND MEDIUM

(71) Applicant: CANON KABUSHIKI KAISHA, Tokyo (JP)

(72) Inventor: KOICHI SUZUKI, Kanagawa (JP)

(21) Appl. No.: 19/701,940

(22) Filed: Jun. 9, 2026

Related U.S. Application Data
(63) Continuation of application No. PCT/JP2024/044349, filed on Dec. 16, 2024.

(30) Foreign Application Priority Data
Dec. 18, 2023 (JP) 2023-212900
Oct. 23, 2024 (JP) 2024-186737

(51) Int. Cl. G01N 21/64

(52) U.S. Cl. CPC G01N 21/6402; G01N 21/6486; G01N 2201/0446; G01N 2201/06113; G01N 2201/068; G01N 2201/105; G01N 2201/123; G01N 2201/125; G01N 2201/129

(57) ABSTRACT

A sample measuring method includes: irradiating an array substrate with condensed primary light; detecting secondary light from a spot to output a detection signal; relatively changing an irradiation position of the primary light with respect to the array substrate; acquiring information on a relative position of the primary light with respect to the array substrate; and converting the detection signal acquired in a predetermined period into digital data. The sample measuring method further includes: holding information on a target position Pt set relating to the irradiation position of the primary light; determining that the irradiation position has reached the target position Pt based on the information on the relative position; and selecting digital data including digital data corresponding to a predetermined period from the digital data in accordance with a determination result, and transferring the selected digital data to storage means for storing the digital data.

### CROSS-REFERENCE TO RELATED APPLICATIONS

This application is a Continuation of International Patent Application No. PCT/JP2024/044349, filed Dec. 16, 2024, which claims the benefit of Japanese Patent Application No. 2023-212900, filed Dec. 18, 2023, and Japanese Patent Application No. 2024-186737, filed Oct. 23, 2024, all of which are hereby incorporated by reference herein in their entirety.

### BACKGROUND

### Field of the Technology

The present disclosure relates to a sample measuring apparatus for measuring a sample, a sample measuring method, and a medium.

### Description of the Related Art

A protein array plate or a peptide array plate in which a large number of biological substances having peptide bonds, such as proteins and peptides, are immobilized on a substrate is known. Through use of those array plates, interactions with a large number of biological substances immobilized on the substrate are examined at once. That is, those array plates are effective in comprehensively analyzing interactions between a large number of proteins or peptides and biological liquid samples, blood, cell extracts, saliva, interstitial fluid, or the like. With such analysis, characteristics of a sample are measured. In the following, an immobilized site of a protein or a peptide on a substrate is referred to as “spot.”

As a method of observing a spot subjected to an interaction with a sample, there is known a method of identifying a spot subjected to an interaction by labeling the spot with a fluorescent probe. Further, as an apparatus for observing an array plate labeled with a fluorescent probe, a fluorescence image scanner is known (U.S. Pat. No. 7,911,670). The fluorescence image scanner as disclosed in U.S. Pat. No. 7,911,670 includes an irradiation optical system, a fluorescence detection optical system, and a two-dimensional scanning system. The irradiation optical system has a function of condensing and applying a laser beam to the array plate. The fluorescence detection optical system has a function of detecting a light amount of fluorescence from a spot irradiated with a laser beam and labeled with a fluorescent probe. The two-dimensional scanning system has a function of two-dimensionally scanning the array plate or an optical system to change an irradiation position of a laser beam on the array plate and acquiring a captured image reflecting a light amount of fluorescence excited by the laser beam at a spot. Further, a confocal optical system is used as the fluorescence detection optical system.

Further, in Japanese Patent Laid-Open No. 2018-81136, there is disclosed a technology of acquiring optical signals at equal intervals by adjusting a phase of a sampling clock for detecting a light amount of fluorescence from a spot in accordance with a scanning timing of two-dimensional scanning. In the two-dimensional scanning mechanism in the related art, reciprocating scanning of a laser beam is performed at a high speed in a main scanning direction by a piston-crank mechanism or a galvano scanner mechanism. Further, in the related art, the light amount of fluorescence from a spot is converted into an analog signal by a highly sensitive sensor such as a photomultiplier tube, and is further converted into optical signal data which is a digital value by AD conversion. In general, the AD conversion requires a predetermined conversion time determined by a clock frequency of an AD converter and a peripheral circuit.

In the related-art fluorescence image scanner, a moving time required for a condensing unit for condensing an applied laser beam to move between points at which an optical signal is to be acquired is determined in consideration of a scanning speed of a two-dimensional scanning mechanism. Specifically, the clock frequency of the AD converter and the peripheral circuit is determined so that AD conversion is completed in a time shorter than the moving time. However, due to a mechanical vibration or the like when the laser beam is reciprocated and scanned by the two-dimensional scanning mechanism, local variations in a scanning speed of the laser beam occur. For this reason, variations occur in a time for scanning between the points at which the optical signal is to be acquired. As a result, before the AD conversion of the optical signal of the previous point is completed, the point at which the next optical signal is to be acquired is passed, which may lead to omission of acquisition of the optical signal. When the optical signal is attempted to be acquired at short acquisition intervals in order to improve image quality of the captured image, the possibility of occurrence of such a problem further increases.

As a countermeasure against such a problem, it is conceivable, for example, to select an AD converter having a higher speed and a shorter conversion time, or to sufficiently reduce local speed variations by using a more robust scanning mechanism. However, execution of those countermeasures leads to an increase in cost and size of the apparatus. Meanwhile, when a speed of reciprocating scanning is slowed down in consideration of local speed variations, a photographing time becomes longer. Further, when an acquisition interval is lengthened without changing the scanning speed, a sufficient number of pieces of optical signal data cannot be acquired, which may lower measurement accuracy.

### SUMMARY

The present disclosure has been made in view of such a situation, and is directed to providing a sample measuring apparatus and a control method for a sample measuring apparatus with which optical signal data can be stably acquired with a simple configuration even when variations in a scanning speed occur.

A sample measuring apparatus according to one aspect of the present disclosure is a sample measuring apparatus for optically measuring characteristics of a sample by using an array substrate on which spots are provided in an array, the sample measuring apparatus including: light irradiation means for irradiating the array substrate with condensed primary light for a predetermined period; light detection means for detecting secondary light from each of the spots at a predetermined cycle to output a detection signal; scanning means for changing an irradiation position of the primary light with respect to the array substrate; position acquisition means for acquiring information on the irradiation position; conversion means for converting the detection signal acquired at the predetermined cycle into digital data; first holding means for holding information on a target position Pt relating to the irradiation position; second holding means for holding the digital data; determination means for determining whether the irradiation position corresponds to the target position Pt; storage means for storing the digital data; and transfer means for selecting data corresponding to a timing at which the irradiation position has reached the target position Pt from the digital data held in the second holding means in accordance with a determination result obtained by the determination means, and transferring the selected data to the storage means.

Further, a control method for a sample measuring apparatus according to one aspect of the present disclosure is a control method for a sample measuring apparatus including: first holding means for holding a target position relating to an irradiation position of primary light in order to optically measure characteristics of a sample by using an array substrate on which spots are provided in an array; second holding means for holding, as digital data, a detection signal detected by measurement of secondary light from each of the spots; and storage means for storing the irradiation position and the digital data in association with each other, the control method including: a light irradiation step of irradiating the array substrate with condensed primary light for a predetermined period; a light detection step of detecting the secondary light from each of the spots at a predetermined cycle to output a detection signal; a scanning step of changing the irradiation position of the primary light with respect to the array substrate; a position acquisition step of acquiring information on the irradiation position; a conversion step of converting the detection signal acquired at the predetermined cycle into the digital data; a determination step of determining whether the irradiation position corresponds to a target position Pt; and a transfer step of selecting data corresponding to a timing at which the irradiation position has reached the target position Pt from the digital data held in the second holding means in accordance with a determination result determined in the determination step, and transferring the selected data to the storage means.

Features of the present disclosure will become apparent from the following description of embodiments with reference to the attached drawings.

### BRIEF DESCRIPTION OF THE DRAWINGS

FIG. 1 is a diagram for illustrating a schematic configuration of a sample measuring apparatus according to a first embodiment.

FIG. 2A is an explanatory view of a sample targeted by the present disclosure, and is a view of an array plate as viewed from above.

FIG. 2B is an explanatory view of a sample targeted by the present disclosure, and is a view of the array plate as viewed from a side.

FIG. 3 is a diagram for illustrating an internal configuration of a controller in the first embodiment.

FIG. 4 is a chart for illustrating an operation flow of photographing processing in the first embodiment.

FIG. 5A is an explanatory diagram of a positional relationship of sub-scanning of the photographing processing in the first embodiment, and is a diagram of the array plate as viewed from above.

FIG. 5B is an explanatory diagram of a positional relationship of sub-scanning of the photographing processing in the first embodiment, and is a diagram for schematically illustrating a locus of excitation light on the array plate.

FIG. 6A is an explanatory diagram of a positional relationship of height scanning of the photographing processing in the first embodiment, and is a diagram for illustrating an example in which the array plate is viewed from a side.

FIG. 6B is an explanatory diagram of a positional relationship of height scanning of the photographing processing in the first embodiment, and is a diagram for illustrating an example in which the array plate is viewed from a side.

FIG. 7 is a diagram for illustrating a functional configuration provided inside a receiving circuit in the first embodiment.

FIG. 8 is a chart for illustrating an operation timing of the photographing processing in the first embodiment.

FIG. 9A is a timing chart relating to an operation of optical signal data acquisition in the related art.

FIG. 9B is a timing chart relating to an operation of optical signal data acquisition in the related art.

FIG. 9C is a timing chart relating to an operation of optical signal data acquisition in the first embodiment.

FIG. 9D is a timing chart relating to an operation of optical signal data acquisition in the first embodiment.

FIG. 9E is a timing chart relating to an operation of optical signal data acquisition in an embodiment.

FIG. 9F is a timing chart relating to an operation of optical signal data acquisition in an embodiment.

FIG. 10 is a chart for illustrating an operation flow of height information acquisition processing in the first embodiment.

FIG. 11A is an explanatory diagram of a positional relationship of height scanning of the height information acquisition processing in the first embodiment, and is a diagram of the array plate as viewed from a side.

FIG. 11B is an explanatory diagram of a positional relationship of height scanning of the height information acquisition processing in the first embodiment, and is a diagram of the array plate as viewed from a side.

FIG. 11C is an explanatory diagram of a positional relationship of height scanning of the height information acquisition processing in the first embodiment, and is a diagram in which a light amount of reflected light acquired by an optical sensor during height scanning is plotted for each height.

FIG. 12 is a chart for illustrating an operation flow of photographing processing in a second embodiment.

FIG. 13 is a diagram for illustrating a relationship between acquisition positions of optical signal data in the second embodiment.

FIG. 14A is an explanatory diagram of processing contents of level conversion in a third embodiment, and is a diagram for illustrating a relationship between an output voltage of a current-voltage conversion amplifier and a digital value of output of an AD converter.

FIG. 14B is an explanatory diagram of processing contents of level conversion in the third embodiment, and is a diagram for illustrating an input/output relationship from voltage level conversion inside the receiving circuit to the AD converter.

FIG. 14C is an explanatory diagram of processing contents of level conversion in the third embodiment, and is a diagram for illustrating an input/output relationship of pixel level conversion in image forming processing.

FIG. 15 is a diagram for illustrating a relationship between optical signal data acquisition positions in a fourth embodiment.

FIG. 16 is an explanatory diagram of an operation of a piston-crank mechanism in one aspect of the present disclosure.

FIG. 17 is a diagram for illustrating first holding means, second holding means, and determination means in the first embodiment.

FIG. 18 is a diagram for illustrating conversion means in the first embodiment.

### DESCRIPTION OF THE EMBODIMENTS

Exemplary embodiments for carrying out the present disclosure are described in detail below with reference to the attached drawings. The embodiments described below do not limit the present disclosure set forth in the appended claims. A plurality of features are described in the embodiments, but the present disclosure does not necessarily require all of those plurality of features, and a plurality of features may be combined as appropriate. Further, for example, dimensions, materials, shapes, and relative positions of components described in the following embodiments may be freely selected and can be changed depending on a configuration of an apparatus to which the present disclosure is applied or on various conditions. Further, in the accompanying drawings, the same reference symbols are used throughout the drawings to indicate the same or functionally similar elements, and redundant description is omitted.

### First Embodiment

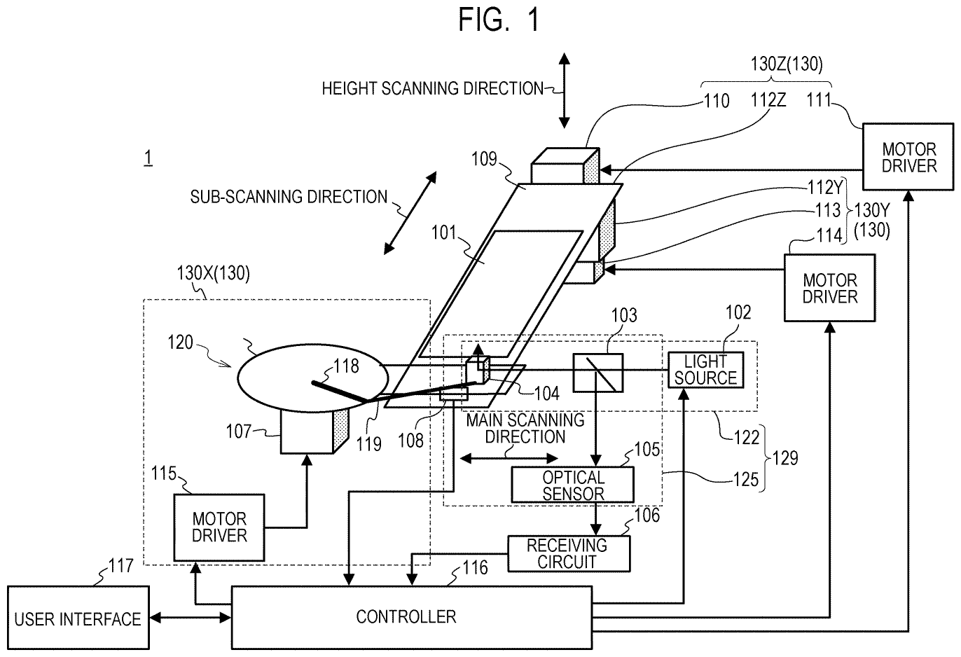

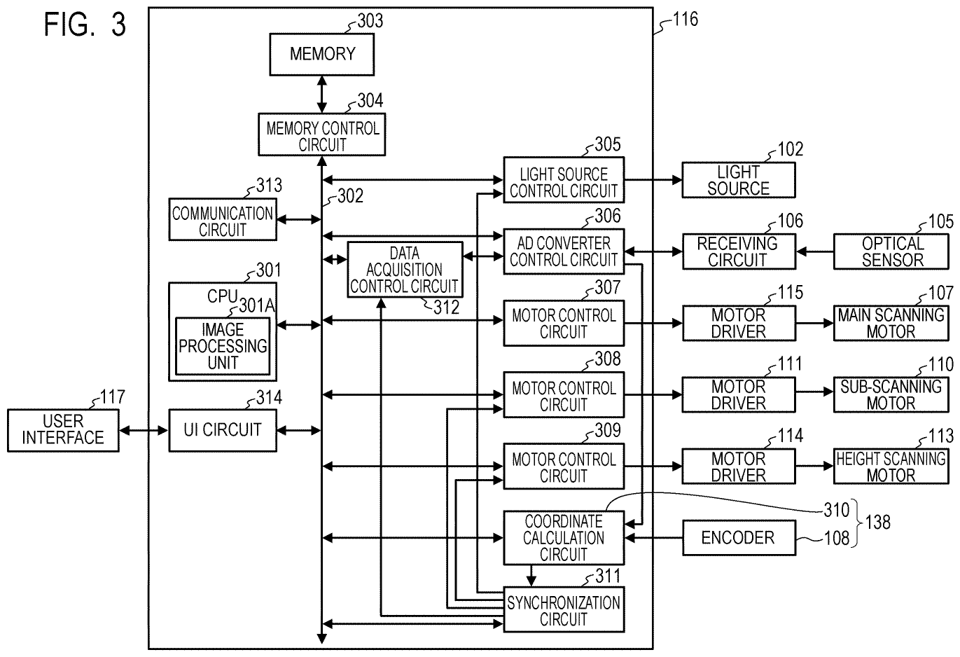

In the following, a first embodiment of the present disclosure in which sample measurement is performed by placing the above-mentioned array plate on a sample measuring apparatus illustrated in FIG. 1 is described with reference to FIG. 3 to FIG. 11C. Here, a schematic configuration of the sample measuring apparatus according to the present disclosure is first described with reference to FIG. 1. A sample measuring apparatus 1 illustrated in FIG. 1 sets, as a measurement target, an array plate 101 which is fluorescently labeled and has spots of a large number of biological substances immobilized on a glass slide. The sample measuring apparatus 1 includes an objective optical system, conversion means, scanning means, and detection means. The objective optical system has a configuration for application of excitation light and reception of fluorescence described later, and the conversion means has a configuration for converting received fluorescence into an electrical signal. The scanning means has a configuration for scanning the excitation light relative to the array plate 101, and the detection means has a configuration for detecting information on the sample from the received fluorescence. Each configuration is sequentially described below.

### <Objective Optical System>

As illustrated in FIG. 1, the sample measuring apparatus 1 includes an objective optical system 129 as an optical system for acquiring a fluorescence image of the array plate 101. The objective optical system 129 is configured such that emitted light from a light source 102 passes through an objective lens and is focused on a sample surface, and secondary light passes through the objective lens again and light focused by an optical sensor 105 described later is received through a pinhole. The objective optical system 129 includes light irradiation means 122 and light detection means 125 having coaxially arranged elements shared with each other. The light irradiation means 122 irradiates the array plate 101 with condensed primary light for a predetermined period, and the light detection means 125 detects secondary light from each of the spots at a predetermined cycle to output a detection signal.

### <Light Irradiation Means>

The light irradiation means 122 includes a light projection unit 104 including an objective lens for irradiating the array plate 101 with condensed primary light, a confocal optical system 103 including a beam splitter and a pinhole (not shown), and the light source 102. The light projection unit 104 may also be referred to as an objective lens, a light exiting unit, a primary light emission unit, a primary light exiting unit, or the like.

### <Light Detection Means>

The light detection means 125 includes the light projection unit 104 that collects secondary light from the spot, the confocal optical system 103, and the optical sensor 105. The optical sensor 105 includes a detection element capable of detecting a wavelength of secondary light with high sensitivity and a high dynamic range. A photomultiplier tube (PMT), a semiconductor sensor, or the like is employed.

The light source 102 is a semiconductor laser that emits excited light having wavelengths of around 670 nm and around 780 nm (hereinafter referred to as “excitation light”). In the sample measuring apparatus 1, emission and stop of light of each wavelength can be independently controlled. The confocal optical system 103 guides the excitation light from the light source 102 to the array plate 101, and guides fluorescence from the spot on the array plate 101 and reflected light from the surface of the glass slide to the optical sensor. In this example, the confocal optical system 103 includes a pinhole, a filter, a dichroic mirror, a ¼ wavelength plate, a polarization beam splitter, and a lens. Through use of the confocal optical system 103, the influence of an autofluorescence component from the glass slide is reduced, and a signal-to-noise ratio when a spot-derived fluorescence component is measured is increased. The light projection unit 104 is used to condense and apply the excitation light to the spot on the array plate 101, and includes a prism for directing the excitation light toward the array plate 101, and a lens for condensing the excitation light onto the spot on the array plate 101. The forms of the confocal optical system 103 and the light projection unit 104 are not limited to the examples given here, and can be replaced with various publicly-known configurations as long as equivalent functions are obtained.

The optical sensor 105 is provided to convert fluorescence into an electrical signal, and includes a photomultiplier tube for acquiring fluorescence and a photodiode for acquiring reflected light. The optical sensor 105 can separately acquire the fluorescence from the spot on the array plate 101 and the reflected light from the surface of the array plate 101. Further, the optical sensor 105 includes a plurality of photomultiplier tubes corresponding to a plurality of wavelengths of the light source 102, a photodiode, and the like.

### <Conversion Means>

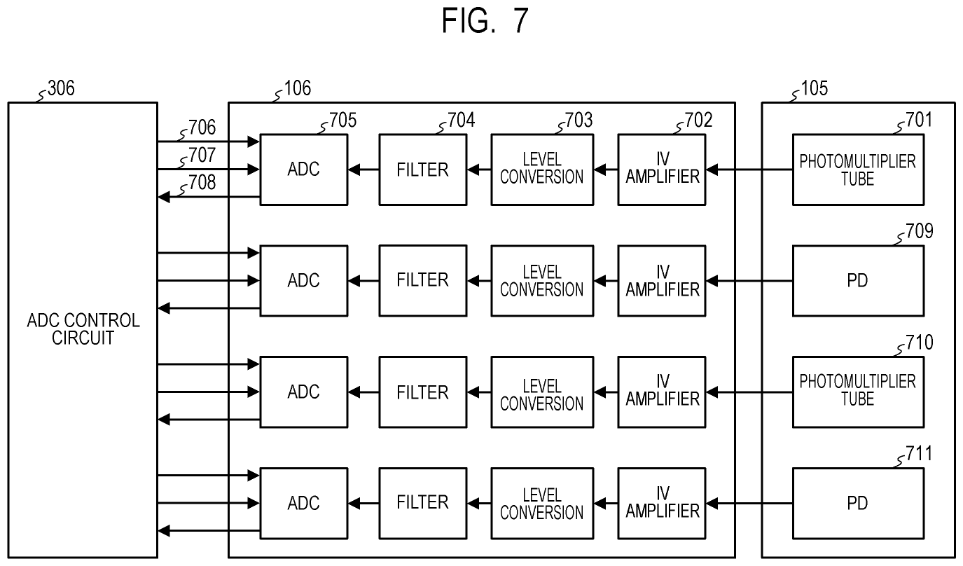

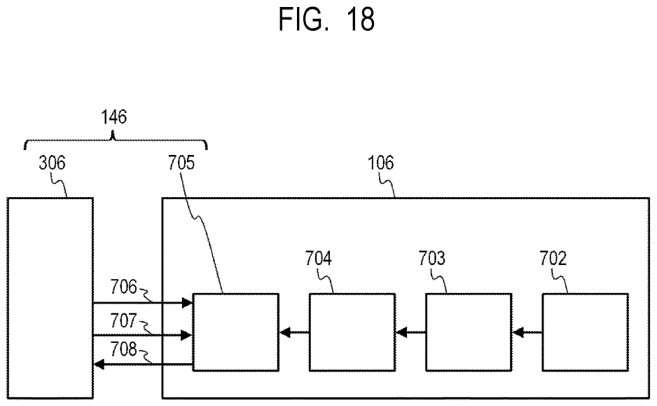

As illustrated in FIG. 18, the sample measuring apparatus 1 includes conversion means 146 for converting a detection signal acquired at a predetermined cycle into digital data. The conversion means 146 includes an AD converter 705 arranged in a receiving circuit 106 and an AD converter control circuit 306 that controls the receiving circuit 106. As illustrated in FIG. 18 or FIG. 7 to be referred to later, the receiving circuit 106 is a receiving circuit for amplifying a detection signal from a photomultiplier tube 701 included in the optical sensor 105 and converting the detection signal into a digital value. The receiving circuit 106 includes an amplifier circuit (current-voltage conversion amplifier 702), a level conversion circuit (level conversion circuit 703), a filter circuit (filter circuit 704), an AD converter (ADC 705), and the like.

### <Scanning Means>

As illustrated in FIG. 1, the sample measuring apparatus 1 includes scanning means 130 for changing an irradiation position Pi of the primary light with respect to the array plate 101. The scanning means 130 includes, as mechanisms for scanning the light projection unit 104 two-dimensionally with respect to the array plate 10, main scanning means 130x for moving the light projection unit 104 in an X direction in the two dimensions and sub-scanning means 130y for moving the array plate 101 in a Y direction. The main scanning means 130x includes a pulse motor 107, a linear stage 109, a motor driver 115, and a piston-crank mechanism 120. The piston-crank mechanism 120 includes a crank 118 and a connecting rod 119. The sub-scanning means 130y includes a linear stage 112y, a pulse motor 113, and a motor driver 114. The scanning means 130 further includes z-direction scanning means 130z for moving the array plate 101 relative to a base material (not shown) in a Z direction perpendicular to a plane defined in the XY directions. The z-direction scanning means 130z includes a linear stage 112z that moves the linear stage 109 in the Z direction, a pulse motor 110 that drives the linear stage 112z, and a motor driver 111 that controls the pulse motor 110. The scanning means 130 is fixed to a scanning means base material (housing) (not shown). Here, a pulse motor or the like is given as an example of a drive source for generating a driving force, but a drive mechanism such as another type of publicly-known motor may be used as the drive source.

The piston-crank mechanism 120 reciprocates the light projection unit 104 in a short-side direction of the array plate 101. The excitation light from the light source 102 is scanned in the short-side direction of the array plate 101 by the reciprocating motion of the light projection unit 104. Here, the short-side direction of the array plate 101 is referred to as “main scanning direction,” and reciprocating scanning performed by the piston-crank mechanism 120 is referred to as “main scanning.” Further, a stroke of the main scanning shown here is 30 mm. The light projection unit 104 is limited in operation direction to the main scanning direction by a guide (not shown) in the main scanning direction. The pulse motor 107 is a pulse motor for rotating the piston-crank mechanism 120 at a high speed, and a rotational speed of from 100 rpm to 10,000 rpm is adopted for the pulse motor 107 shown here, and preferably, a rotational speed of from 500 rpm to 2,000 rpm is adopted.

### <Position Acquisition Means>

The sample measuring apparatus 1 includes position acquisition means 138 (see FIG. 3) for acquiring position information on the irradiation position of the primary light on the array plate 101. The position acquisition means 138 includes a linear encoder 108 that moves integrally with the light projection unit 104 illustrated in FIG. 1, and a coordinate calculation circuit 310 to be described later.

The linear encoder 108 is a linear encoder installed in the piston-crank mechanism 120, and measures a position of the light projection unit 104 in the main scanning direction. The linear encoder 108 outputs a phase difference pulse voltage including an A phase, a B phase, and a Z phase in accordance with the position in the main scanning direction.

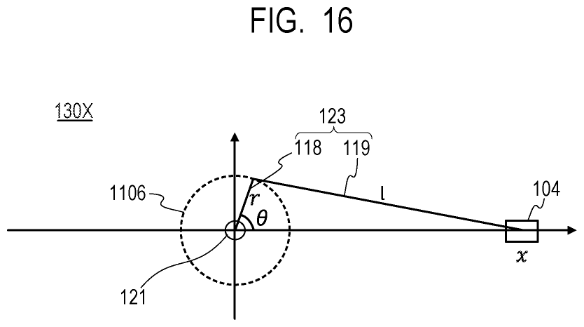

Here, a specific configuration of the piston-crank mechanism 120 used in the sample measuring apparatus 1 illustrated in FIG. 1 is described with reference to FIG. 16. FIG. 16 shows an example of the schematic configuration of the piston-crank mechanism 120. The piston-crank mechanism 120 includes a piston crank unit 123 including the crank 118 and the connecting rod 119, and a rotary drive unit 121. FIG. 16 shows a positional relationship among the crank 118, the connecting rod 119, and the light projection unit 104 in the piston-crank mechanism 120. The crank 118 is a crank that forms the piston-crank mechanism 120, and is connected to a rotation shaft of the pulse motor 107 and the connecting rod 119 via a joint. In this embodiment, the pulse motor 107 forms the rotary drive unit 121 in the present disclosure, and is connected to one end of the crank 118. The other end of the crank 118 is connected to one end of the connecting rod 119. The other end of the connecting rod 119 is connected to the light projection unit 104. With such a configuration, the rotational motion of the rotary drive unit 121 allows the light projection unit 104 to perform a one-dimensional reciprocating motion along an arrow direction illustrated in FIG. 16.

The linear stage 109 moves the array plate 101 in a horizontal plane in a direction orthogonal to the main scanning. The linear stage 109 includes a ball screw, an origin sensor, and the like. In the following, scanning in a direction orthogonal to the main scanning in the horizontal plane is referred to as “sub-scanning.” A placement table for placing the array plate 101 is provided on the linear stage 109, and a user places the array plate 101 as a measurement target on the placement table in advance. The pulse motor 110 is connected to the linear stage 109. Rotational motion of the pulse motor 110 is converted into linear motion by the ball screw of the linear stage 109. The motor driver 111 rotates the pulse motor 110. When the motor driver 111 inputs one pulse of a signal to the pulse motor 110, the pulse motor 110 rotates by 0.72°, and here, the array plate 101 moves by 2 μm in the sub-scanning direction.

The linear stage 112z moves the array plate 101 in a vertical direction. The linear stage 112z includes a ball screw, an origin sensor, and the like. In the following, scanning in the vertical direction is referred to as “height scanning.” The pulse motor 113 is connected to the linear stage 112z. Rotational motion of the pulse motor 113 is converted into linear motion by the ball screw of the linear stage 112z. The motor driver 114 rotates the pulse motor 113. When the motor driver 114 inputs one pulse of a signal to the pulse motor 113, the pulse motor 113 rotates by 0.72°, and here, the array plate 101 moves upward by 1 μm in the vertical direction (height scanning). The motor driver 115 rotates the pulse motor 107. When the motor driver 115 inputs one pulse of a signal to the pulse motor 107, the pulse motor 107 rotates by 0.72°, and here, the light projection unit 104 moves along the main scanning direction. The configuration described here regarding relative movement of the light projection unit 104 (irradiation position of excitation light) with respect to the array plate 101 is an example, and there is no limitation on which of those configurations moves and how the configurations move, as long as relative movement between those configurations is possible.

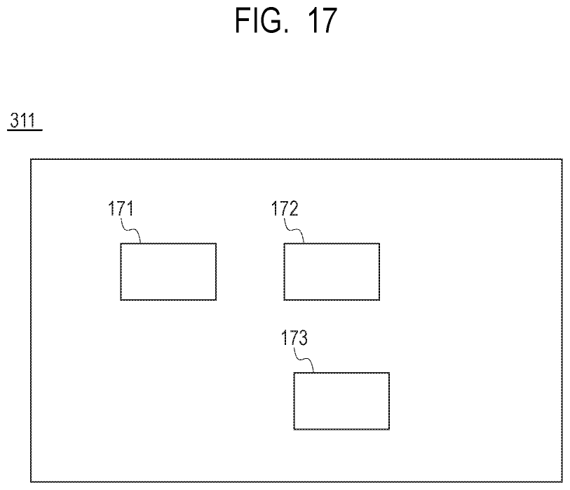

The sample measuring apparatus 1 further includes a controller circuit 116. The controller circuit 116 controls the entire sample measuring apparatus 1, and includes an FPGA, a CPU, a memory, embedded software, and the like. More specifically, the controller circuit 116 controls the light source 102, the motor driver 111, the motor driver 114, and the motor driver 115 to scan the excitation light on the array plate 101 in the main scanning direction, the sub-scanning direction, and the height direction. Further, the controller circuit 116 acquires information on the irradiation position Pi of the irradiation light (primary light) output from the linear encoder 108 and optical signal data from the optical sensor 105. In addition, the controller circuit 116 holds the information and the data in first holding means 171 and second holding means 172 (see FIG. 17) to be described later. The first holding means 171 holds the information on the irradiation position Pi for a period (at least temporarily) in which determination means 173 (see FIG. 17) to be described later can use the information, by storing the information on the irradiation position Pi in a readable state.

The controller circuit 116 includes therein means for acquiring height information and tilt information of the array plate 101, and means for generating pulse trains for main scanning, sub-scanning, and height scanning. The corresponding means are motor control circuits 307 to 309 and the coordinate calculation circuit 310 illustrated in FIG. 3 which are to be described later. Further, as illustrated in FIG. 3, the controller circuit 116 includes an AD converter control circuit 306 as AD converter control means and a synchronization circuit 311 as synchronization control means. Further, the controller circuit 116 includes a data acquisition control circuit 312 as data acquisition control means and a memory 303 as storage means. That is, in the embodiments described below, those means provided in the controller circuit 116 include various circuits illustrated in FIG. 3. In this case, the AD converter control means gives a conversion instruction to the AD converter 705 (see FIG. 7) of the receiving circuit 106, AD-converts an electrical signal corresponding to a light amount of the optical sensor 105, and acquires optical signal data which is a digital value. At that time, in the following embodiments, the controller circuit 116 acquires optical signal data at a cycle shorter than the shortest time required for the irradiation position Pi of the primary light to pass through an interval between target positions Pt by using those configurations.

The synchronization circuit 311, which is the synchronization control means, controls sub-scanning and height scanning in synchronization with position information lip of the irradiation position Pi of the primary light. Thus, a thickness and a tilt of the array plate 101 are corrected when the light projection unit 104 corresponding to the irradiation position Pi of the primary light is outside a photographing range on the array plate 101, and the excitation light is focused on a surface in which spots are immobilized in the entire array plate 101. Further, the synchronization circuit 311 controls a timing of light emission of the light source 102 and transfer of the optical signal data to the memory. As synchronization control, the synchronization circuit 311 instructs the data acquisition control means to transfer the optical signal data to the memory 303 when the irradiation position Pi of the primary light reaches the target position Pt so that the excitation light can be applied to a predetermined position. Further, the synchronization circuit 311 controls the start of sub-scanning and height scanning, and the emission (ON) and stop (OFF) of the semiconductor laser of each wavelength of the light source 102 when the light projection unit 104 reaches a position at which the excitation light can be applied to a predetermined position close to an end portion of the array plate 101.

### <First Holding Means>

Now, details of the synchronization circuit 311 provided in the sample measuring apparatus 1 in this embodiment are described with reference to FIG. 17. FIG. 17 is a block diagram for illustrating a functional configuration provided in the synchronization circuit 311 in this embodiment. In this embodiment, the synchronization circuit 311 includes the first holding means 171, the second holding means 172, and the determination means 173. The first holding means 171 illustrated in FIG. 17 holds data Itp related to the target position Pt regarding the irradiation position Pi. Although a configuration in which the first holding means 171 is arranged in the synchronization circuit 311 is given as an example here, the arrangement of the first holding means 171 is not limited to this example.

### <Second Holding Means>

Further, as illustrated in FIG. 17, the synchronization circuit 311 in this embodiment also includes the second holding means 172 for holding digital data converted from the detection signal by the conversion means 146. Although a configuration in which the second holding means 172 is arranged in the synchronization circuit 311 is given as an example here, the arrangement of the second holding means 172 is not limited to this example.

### <Determination Means>

Further, as illustrated in FIG. 17, the synchronization circuit 311 in this embodiment includes the determination means 173 for determining whether or not the irradiation position Pi has reached the target position Pt. The determination means 173 determines that the irradiation position Pi of the primary light has reached the target position Pt based on information on a relative position obtained from the linear encoder 108 or the like. Although a configuration in which the determination means 173 is arranged in the synchronization circuit 311 is given as an example here, the arrangement of the second holding means 172 is not limited to this example.

### <Transfer Means>

Further, as illustrated in FIG. 3, the sample measuring apparatus 1 includes the data acquisition control circuit 312 (see FIG. 3) that selects data corresponding to the irradiation position corresponding to the target position from the digital data held in the second holding means 172 in accordance with a determination result obtained by the determination means 173. A memory control circuit 304 connected to the data acquisition control circuit 312 functions as transfer means for transferring the selected data to the storage means (memory 303) in this embodiment. The data acquisition control circuit 312 temporarily saves the optical signal data from the AD converter control means, and the memory control circuit 304 transfers the latest optical signal data to the memory based on a synchronization control instruction from the synchronization circuit 311. In the following embodiments, when new optical signal data is acquired before an instruction is given from the synchronization circuit 311, old optical signal data is overwritten. Thus, the acquisition of optical signal data is performed at a constant cycle, but the optical signal data acquired at a time closest to when the irradiation position Pi of the primary light reaches the target position Pt is selectively transferred to the memory 303 and saved.

The sample measuring apparatus 1 illustrated in FIG. 3 further includes a user interface 117. The user interface 117 is used for receiving an instruction from a user and displaying a result, for example, and includes a keyboard, a mouse, and a display. The controller circuit 116 receives an instruction to photograph the array plate 101 via the user interface 117, and presents image data based on the optical signal data to the user, for example. Further, the user specifies a photographing range and a pixel pitch in the main scanning direction and the sub-scanning direction via a GUI on the user interface 117 when the array plate 101 is photographed.

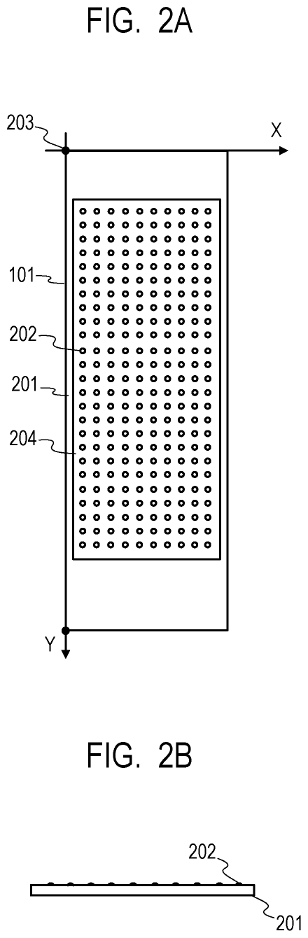

Next, a sample targeted by the present disclosure is described with reference to FIG. 2A and FIG. 2B. FIG. 2A is a view of the array plate 101 as viewed from above, and FIG. 2B is a view of the array plate 101 as viewed from a side. The array plate 101 includes a glass slide 201 which is a substrate, and spots 202 provided on the glass slide 201. A biological substance containing a peptide bond is immobilized on each spot 202. A large number of spots 202 are provided on the glass slide 201, and one kind of biological substance is immobilized on one spot. In the following embodiments, a spot diameter of about 100 μm is adopted, and a spot interval (distance from an end of a spot to an end of the next spot) is 200 μm. Further, a length in the short-side direction of the array plate is 25 mm, and a length in a long-side direction thereof is 75 mm.

Here, a point 203 at an upper left (corner) of the array plate 101 is regarded as an origin, a rightward direction in the short-side direction is regarded as a positive direction of an X-axis, and a downward direction in the long-side direction is regarded as a Y-axis direction. When units of X and Y coordinates are μm, sets of coordinates of respective four corners of the array plate are (0, 0), (25,000, 0), (0, 75,000), and (25,000, 75,000). When a stroke of the piston-crank mechanism 120 is 30 mm, the stroke becomes 5 mm longer than the length of the array plate 101. That is, in the main scanning, the excitation light is scanned up to a range that is 2.5 mm longer on the left and right of the array plate, and the X coordinate of a scanning range is within a range of from −2,500 to 27,500.

Meanwhile, the spots 202 are provided within a range of a region 204 on the glass slide 201. That is, on the glass slide 201, there is a region in which the spots 202 exist and a region in which the spots 202 do not exist due to convenience in creating the spots 202 and convenience in gripping by the user. In the following embodiments, sets of coordinates of respective four corners of the region 204 are (2,000, 2,000), (23,000, 2,000), (2,000, 65,000), and (23,000, 65,000). Further, a Y coordinate range of the sub-scanning can be specified by the user.

FIG. 3 partially described above is a block diagram for illustrating an internal configuration of the controller circuit 116 in the first embodiment of the present disclosure. The controller circuit 116 includes a CPU 301 for operating control software for controlling the entire sample measuring apparatus 1, and the CPU 301 includes a microprocessor, a cache memory, and the like. Further, the CPU 301 is connected to various peripheral circuits to be described later via a bus 302. Further, the CPU 301 can include an image processing unit 301a, and images characteristics of the sample by using digital data based on the optical signal data stored in the memory 303 to be described later.

The various peripheral circuits include the memory 303, the memory control circuit 304, a light source control circuit 305, the AD converter control circuit 306, the motor control circuits 307 to 309, the coordinate calculation circuit 310, and the synchronization circuit 311. Further, the various peripheral circuits further include the data acquisition control circuit 312, a communication circuit 313, and a user interface (UI) control circuit 314.

### <Storage Unit>

The memory 303 is otherwise referred to as “storage means,” and stores data of pixel values and coordinate values forming a fluorescence image. The memory 303 may further save photographing conditions input from a user, control parameters of the sample measuring apparatus 1, and optical signal data. The memory 303 includes a double data rate (DDR)-4 synchronous dynamic random access memory (SDRAM), a solid state drive (SSD), or the like. The memory control circuit 304 controls the memory 303 based on an access command to the memory 303 obtained via the bus 302. The light source control circuit 305 is a light source control circuit for the CPU 301 to control the light source 102, and includes an interface conversion circuit, a DA converter, and the like. The CPU 301 can control ON/OFF of laser irradiation of the light source 102 and a light amount of excitation light to be applied via the light source control circuit 305. The light source control circuit 305 is otherwise referred to as an element of the light irradiation means 122, which is configured to turn ON/OFF light emission of the light source 102.

The AD converter control circuit 306 controls the AD converter of the above-mentioned receiving circuit 106 based on an instruction from the CPU 301 to acquire the optical signal data. The AD converter control circuit 306 outputs a conversion start signal to the AD converter of the receiving circuit 106. The AD converter samples an analog signal in the receiving circuit at a timing at which the conversion start signal is input, converts the sampled analog signal into the optical signal data, and outputs the optical signal data to the AD converter control circuit 306. The AD converter control circuit 306 transfers the optical signal data input from the AD converter to the data acquisition control circuit 312.

The motor control circuit 307 generates a control signal to the motor driver 115 for a main scanning motor based on an instruction from the CPU 301. When the CPU 301 specifies a rotational speed, an acceleration, a moving amount, a rotation direction, and a rotation start timing of the pulse motor 107, the motor control circuit 307 generates a drive pulse voltage corresponding thereto. The motor control circuit 308 generates a control signal to the motor driver 111 for a sub-scanning motor based on an instruction from the CPU 301. When the CPU 301 specifies a rotational speed, an acceleration, a moving amount, a rotation direction, and a rotation start timing of the pulse motor 110, the motor control circuit 308 generates a drive pulse voltage corresponding thereto. The motor control circuit 309 generates a control signal to the motor driver 114 for a height scanning motor based on an instruction from the CPU 301. When the CPU specifies a rotational speed, an acceleration, a moving amount, a rotation direction, and a rotation start timing of the pulse motor 113, the motor control circuit 309 generates a drive pulse voltage corresponding thereto.

The coordinate calculation circuit 310 counts two phase difference pulse signals of an A phase and a B phase from the linear encoder 108 and calculates a position of the light projection unit 104. Here, a resolution of the linear encoder 108 is 1 μm. When a level of the A-phase signal or the B-phase signal changes, and a phase of the A-phase signal is advanced from that of the B-phase signal, the coordinate calculation circuit 310 increases the coordinate of the light projection unit 104 by 1 μm. When a level of the A-phase signal or the B-phase signal changes, and a phase of the B-phase signal is advanced from that of the A-phase signal, the coordinate calculation circuit 310 decreases the coordinate of the light projection unit 104 by 1 μm.

The synchronization circuit 311 generates a trigger signal to be transmitted to each of the data acquisition control circuit 312, the motor control circuit 308, the motor control circuit 309, and the light source control circuit 305 based on the coordinate information obtained from the coordinate calculation circuit 310. The trigger signal to the data acquisition control circuit 312 is hereinafter referred to as “data acquisition trigger signal.” The trigger signal to the motor control circuit 308 is referred to as “sub-scanning trigger signal.” The trigger signal to the motor control circuit 309 is referred to as “height scanning trigger signal.” Further, the trigger signal to the light source control circuit 305 is referred to as “wavelength switching trigger signal.”

When receiving the sub-scanning trigger signal, the motor control circuit 308 outputs a drive pulse train corresponding to a moving amount corresponding to a pixel pitch in the sub-scanning direction to the motor driver 111. The pixel pitch in the sub-scanning direction is specified by the user at the start of photographing, and is saved in the memory 303. When receiving the height scanning trigger signal, the motor control circuit 309 outputs a drive pulse train corresponding to a moving amount in a height scanning direction to the motor driver 114. The moving amount in the height scanning direction is calculated by the CPU 301. A calculation method is described later.

The data acquisition control circuit 312 transfers the optical signal data output from the AD converter control circuit 306 to the memory 303 via the memory control circuit 304. In this embodiment, the data acquisition control circuit 312 includes a buffer memory, a DMA controller, and the like. When receiving the data acquisition trigger signal from the synchronization circuit 311, the data acquisition control circuit 312 transfers the latest optical signal data saved in an internal buffer memory to the memory 303.

The communication circuit 313 connects the sample measuring apparatus 1 to an external network. In this embodiment, the communication circuit 313 uses a communication protocol conforming to the Ethernet (trademark) standard as a communication method. The communication circuit 313 enables remote control of sample photographing and saving of data in an external large-capacity storage by connecting the sample measuring apparatus 1 to an external PC or server.

The UI control circuit 314 connects the sample measuring apparatus 1 to the user interface 117. The UI control circuit 314 includes an input circuit from a keyboard or a mouse, and an image display circuit for controlling a display. Further, the user interface 117 can form a monitor. In this case, the user interface 117 displays an image to the user on a display screen and receives an operation instruction or the like from the user.

In this embodiment, peripheral circuits forming the controller circuit 116 are mounted on a semiconductor chip such as an FPGA or an ASIC. Those peripheral circuits operate in synchronization with a clock. In this embodiment, 1.00 MHz is adopted as a clock frequency.

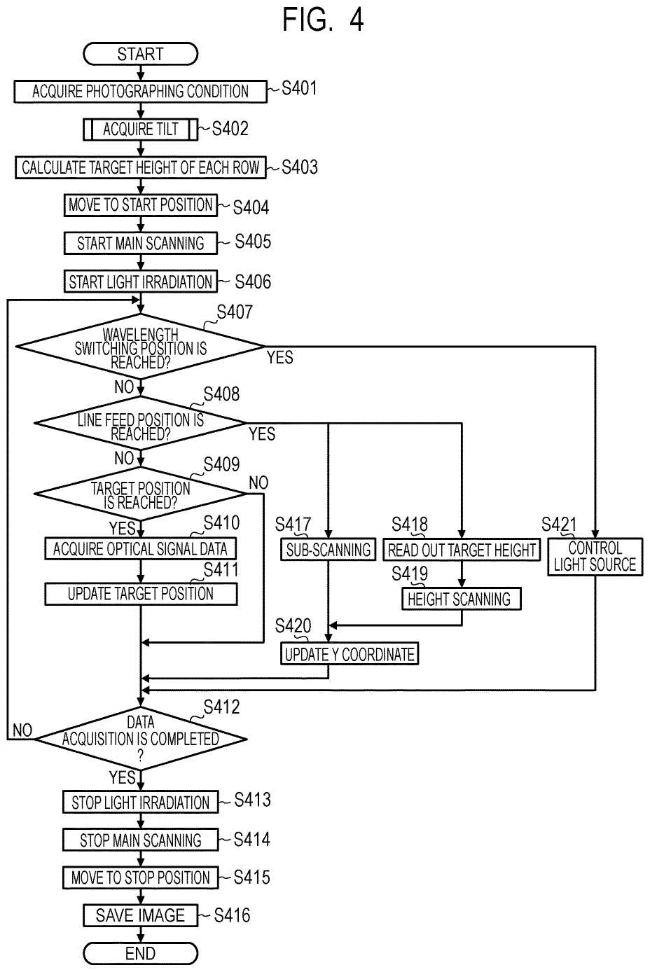

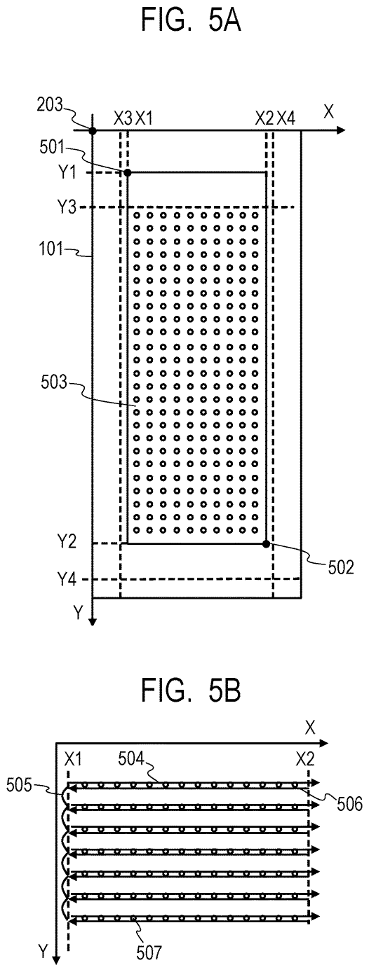

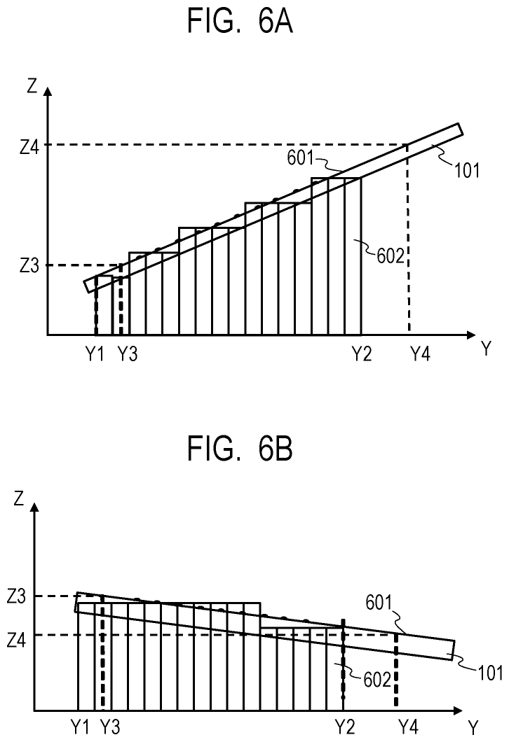

Subsequently, a photographing operation for the array plate 101 in this embodiment is described with reference to FIG. 4, FIG. 5A, FIG. 5B, FIG. 6A, and FIG. 6B. FIG. 4 shows an operation flow when the array plate 101 is photographed by the sample measuring apparatus 1 according to this embodiment. FIG. 5A and FIG. 5B are explanatory diagrams of how sub-scanning is performed on the array plate 101 in the photographing operation. FIG. 5A is a diagram of the array plate 101 as viewed from above, and FIG. 5B is a diagram for schematically illustrating a locus of excitation light on the array plate 101. FIG. 6A and FIG. 6B are explanatory diagrams of a positional relationship of height scanning of the array plate 101 in the photographing operation, and FIG. 6A and FIG. 6B are diagrams for illustrating an example of the array plate 101 as viewed from a side. A thickness and a tilt of the array plate 101 installed in the sample measuring apparatus 1 are different between FIG. 6A and FIG. 6B.

When an instruction to start photographing the array plate 101 is input by the user via the user interface 117, processing steps of Step S401 and subsequent steps are started. In Step S401, the CPU 301 reads photographing conditions specified by the user via the user interface 117 and saves the photographing conditions in the memory 303. Further, the CPU 301 sets information that is based on the photographing conditions in various circuits included in the controller circuit 116.

As the photographing conditions, a point 501 (X1, Y1) and a point 502 (X2, Y2) indicating a photographing range on the array plate 101, a pixel pitch Xp in the main scanning direction, a pixel pitch Yp in the sub-scanning direction, and a rotational speed Xs in the main scanning direction are input. In this embodiment, it is assumed that X1=500, X2=22,500, Y1=500, Y2=64,500, Xp=2 μm, Yp=2 μm, and Xs=1,200 rpm are input. Here, a rectangular photographing region 503 having the point 501 and the point 502 on the array plate 101 as opposite corners is referred to as “photographing region.” Further, the number Nx of pixels in the main scanning direction (Nx=(X2−X1)/Xp) and the number Ny of pixels in the sub-scanning direction (Ny−(Y2−Y1)/Yp) are calculated in advance. In this embodiment, with the above-mentioned settings, Nx=11,000 and Ny=32,000 are obtained. After the reading of the photographing conditions and the above-mentioned settings are completed, the flow proceeds to Step S402.

In Step S402, the CPU 301 acquires height information and tilt information of the array plate 101. Here, a moving amount of the linear stage 112 required for focusing the excitation light on an upper surface of the glass slide 201 forming the array plate 101, that is, a surface thereof on a side on which the spot 202 is located is referred to as “height information.” Further, a tilt of the array plate 101 in the sub-scanning direction is referred to as “tilt information.” In Step S402, Z coordinates Z3 and Z4 serving as height information for two Y coordinates Y3 and Y4 are acquired by measurement.

In this embodiment, it is assumed that Y3=750 and Y4=65,000 are input. Here, when a tilt is as illustrated in FIG. 6A, Z4>Z3 is satisfied, and when a tilt is as illustrated in FIG. 6B, Z3<Z4 is satisfied. An acquisition method for the height information is described later. Further, tilt information K is calculated by Expression 1 below.

K=(Z4−Z3)/(Y4−Y3) (Expression 1)

After the tilt is acquired, the flow proceeds to Step S403.

In Step S403, the CPU 301 calculates a target height of each row of spots in accordance with the photographing conditions, the height information, and the tilt information K. A target height Z(Y) at a coordinate Y of any sub-scanning position is given by Expression 2 below. A target height 601 corresponds to a Z coordinate of a surface of the array plate 101 in FIG. 6A and FIG. 6B.

Z(Y)=K×(Y−Y3)+Z3 (Expression 2)

After the target height is calculated, the flow proceeds to Step S404.

In Step S404, the CPU 301 instructs the motor control circuits 307, 308, and 309 to move the array plate 101 and the light projection unit 104 to a photographing start position. In this embodiment, an X coordinate of the photographing start position is an end portion of a scanning range of the piston-crank mechanism 120, and an X coordinate value is −2,500. Further, a Y coordinate of the photographing start position is Y1 specified in the photographing conditions. A Z coordinate Z1 of the photographing start position is represented by Z(Y1) in Expression 1. After the array plate 101 and the light projection unit 104 are moved to the photographing start position, the flow proceeds to Step S405.

In Step S405, the CPU 301 instructs the motor control circuit 307 to rotate the pulse motor 107 at a rotational speed Xs. Thus, the light projection unit 104 starts a reciprocating motion in the X direction. At this time, an X coordinate of the light projection unit 104 is calculated for each clock by the linear encoder 108 and the coordinate calculation circuit 310, and a calculation result is output to the synchronization circuit 311. The calculated information on a relative position of the light projection unit 104 with respect to the array plate 101 is temporarily saved in a buffer memory provided in the synchronization circuit in this embodiment, and is transmitted to the memory 303 and saved therein as required. After the reciprocating motion is started, the flow proceeds to Step S406.

In Step S406, the CPU 301 instructs the light source control circuit 305 to start light emission of the light source 102. Thus, light irradiation (application of excitation light; hereinafter referred to as “light irradiation”) to the array plate 101 via the light projection unit 104 is started. At this time, through use of the synchronization circuit 311, the array plate 101 is irradiated with light of two kinds of wavelengths of 670 nm and 780 nm while alternately switching between an outward path and a return path of main scanning. As described above, in this embodiment, fluorescences caused by light of two kinds of wavelengths are not simultaneously received by the optical sensor 105, but fluorescence caused by light of each wavelength is individually received by the optical sensor 105. Thus, crosstalk between wavelengths that may occur by simultaneously receiving light is reduced, and measurement accuracy of optical signal data is improved. After the light irradiation is started, the flow proceeds to Step S407.

In Step S407, the synchronization circuit 311 determines whether or not the irradiation position Pi of primary light on the array plate 101 has reached a wavelength switching position. Specifically, the synchronization circuit 311 determines that the wavelength switching position has been reached when an X coordinate of an irradiation position of light applied from the light projection unit 104 onto the array plate 101 output from the coordinate calculation circuit 310 shifts to predetermined positions X3 and X4 outside the photographing region. Here, the irradiation position of the light is obtained as a relative position of the light projection unit 104 in an XY plane on the array plate 101. In this embodiment, coordinates of the positions X3 and X4 are set in advance and saved in the synchronization circuit 311. Further, the positions X3 and X4 which are the wavelength switching positions are set at positions closer to a stroke end of the light projection unit 104 than the positions X1 and X2 which are line feed positions. This is to complete the switching of wavelengths while the light projection unit 104 is outside a photographing range, because a certain amount of time is required to switch wavelengths. In this embodiment, a position X3=200 is adopted, and a position X4=22,800 is adopted.

When the synchronization circuit 311 determines that the light irradiation position has reached the wavelength switching position, the synchronization circuit 311 outputs a wavelength switching trigger signal to the light source control circuit 305, and the flow proceeds to Step S421. Further, when the synchronization circuit 311 determines that the wavelength switching position has not been reached, the synchronization circuit 311 does not output the wavelength switching trigger signal, and the flow proceeds to Step S408.

In Step S408, the synchronization circuit 311 determines whether or not the irradiation position Pi of the primary light has reached a line feed position. The synchronization circuit 311 determines that the line feed position has been reached when the X coordinate of the light projection unit 104 output from the coordinate calculation circuit 310 shifts from inside the photographing region to outside the photographing region. In this embodiment, when a current main scanning direction is a return direction (direction in which the X coordinate decreases), the synchronization circuit 311 determines that the line feed position has been reached when the X coordinate of the light projection unit 104 becomes smaller than X1. Further, in this embodiment, the synchronization circuit 311 does not determine that the line feed position has been reached when the X coordinate of the light projection unit 104 becomes larger than X2.

Scanning in the outward direction is represented by a locus 504 of FIG. 5B. Scanning in the return direction is represented by a locus 506 of FIG. 5B, traces the same locus as the locus in the outward direction in a reverse direction, and returns to the line feed position. An initial value of the main scanning direction is the outward direction, and thereafter, every time the stroke end is reached, the change of the scanning direction to the return direction and the outward direction is alternately repeated.

When the synchronization circuit 311 determines that the line feed position has been reached, the synchronization circuit 311 outputs a sub-scanning trigger signal and a height scanning trigger signal, and executes processing steps of Step S417 and Step S418 in parallel. When the synchronization circuit 311 determines that the line feed position has not been reached, the synchronization circuit 311 does not output the sub-scanning trigger signal and the height scanning trigger signal, and the flow proceeds to Step S409.

In Step S409, the determination means 173 included in the synchronization circuit 311 determines whether or not the irradiation position Pi of the primary light has reached the target position Pt. A point 507 of FIG. 5B indicates a position of a pixel to be imaged on the array plate 101. The target position Pt in this embodiment is a point for acquiring optical signal data on the array plate 101 to generate a pixel, and an X coordinate P(N) of an N-th target position Pt is represented by Expression 3 below.

P(N)=X1+Xp×N(N=0,1, . . . Nx−1) (Expression 3)

The target position is a plurality of points on the locus having a pitch in the X direction of Xp and a pitch in the Y direction of Yp, and coincides with the point 507 which is a position of the pixel in this embodiment. Further, an initial value of the target position Pt is P(0), and is saved in a buffer memory or the like provided inside the synchronization circuit 311. In the first determination of the target position Pt, when the X coordinate of the light projection unit 104 output from the coordinate calculation circuit 310 passes through P(0) in the outward direction (direction in which the X coordinate increases), it is determined that the target position Pt has been reached. In the second and subsequent determinations of the target position Pt, it is determined that the target position Pt has been reached when, for the X coordinate of the light projection unit 104 output from the coordinate calculation circuit 310, the irradiation position Pi passes through the target position Pt updated in Step S411 to be described later. In this embodiment, the target position is generated each time in accordance with a pixel pitch during image generation and the position information lip of the irradiation position Pi from the linear encoder 108 obtained by the synchronization circuit 311. Information on the target position Pt is saved in the buffer memory provided in the synchronization circuit 311 each time. Further, the information on the target position Pt can be transferred to the memory 303 and saved therein as required. That is, in this embodiment, the synchronization circuit 311 temporarily holds the target position Pt calculated each time from the relative position of the light projection unit 104 with respect to the array plate 101 and the pixel pitch. Then, the synchronization circuit 311 determines whether or not the irradiation position Pi of the primary light has reached the target position Pt based on the held target position and the position information obtained from the encoder.

When the synchronization circuit 311 determines that the target position Pt has been reached, the synchronization circuit 311 outputs a data acquisition trigger signal, and the flow proceeds to Step S410. When the synchronization circuit 311 determines that the target position Pt has not been reached yet, the synchronization circuit 311 does not output the data acquisition trigger signal, and the flow proceeds to Step S412.

In Step S410, the AD converter control circuit 306 outputs a conversion start signal, and the receiving circuit 106 amplifies and filters an output voltage from the optical sensor 105, and then AD-converts the output voltage. In this embodiment, the conversion start signal is a signal having a constant cycle, and a cycle thereof is longer than a conversion time of an AD converter, but shorter than a time required for the light projection unit 104 to move the pixel pitch Xp. The AD-converted optical signal data is temporarily saved in a buffer memory inside the data acquisition control circuit 312. The buffer memory can save one piece of optical signal data for one AD converter, and the latest optical signal data is overwritten and saved every time AD conversion is performed. In this embodiment, AD converters corresponding to the respective wavelengths of the light source are provided, and optical signal data reflecting the fluorescence light amount excited by each of the wavelengths of the light source is saved.

When receiving the data acquisition trigger signal, the data acquisition control circuit 312 reads out the optical signal data saved in the buffer memory, and outputs the optical signal data to the memory control circuit 304 via the internal DMA controller and the bus 302. The memory control circuit 304 saves the optical signal data at a designated address in the memory 303. An address of the memory 303 is incremented every time the data acquisition trigger signal is received.

The data acquisition control circuit 312 sets an internal data acquisition completion register to 1 after saving Nx×Ny pieces of optical signal data corresponding to each of the wavelengths of the light source in the memory 303. The data acquisition control circuit 312 sets the internal data acquisition completion register to 0 when the Nx×Ny pieces of optical signal data corresponding to each of the wavelengths of the light source are not saved in the memory 303. After the optical signal data at the target position Pt is saved, the flow proceeds to Step S411.

Subsequently, in Step S411, the first holding means 171 (synchronization circuit 311) updates the target position Pt held inside. When a current main scanning direction is the outward direction (direction in which the X coordinate increases), the target position Pt(N) is incremented to P(N+1) and updated. When the current main scanning direction is the return direction (direction in which the X coordinate decreases), the target position Pt(N) is updated to P(N−1). After the target position Pt is updated, the flow proceeds to Step S412.

In Step S412, the CPU 301 determines whether or not the acquisition of optical signal data is completed. The CPU 301 reads out a data acquisition completion register of the data acquisition control circuit 312, determines that the acquisition of optical signal data is completed when a value thereof is 1, and advances the flow to Step S413. Further, when the value is 0, the CPU 301 determines that the acquisition of optical signal data is not completed, and advances the flow to Step S407.

In Step S413, the CPU 301 instructs the light source control circuit 305 to stop light emission of the light source 102. Thus, light irradiation to the array plate 101 via the light projection unit 104 is stopped. After the light irradiation is stopped, the flow proceeds to Step S414.

In Step S414, the CPU 301 instructs the motor control circuit 307 to stop rotation of the pulse motor 107. Thus, the reciprocating motion of the light projection unit 104 in the X direction stops. After the reciprocating motion is stopped, the flow proceeds to Step S415. In Step S415, the CPU 301 instructs the motor control circuits 307, 308, and 309 to move the array plate 101 and the light projection unit 104 to a stop position. An X coordinate, a Y coordinate, and a Z coordinate of the stop position are 0. Movement to the stop position is executed by returning each unit to an origin in each axis by using a Z-phase pulse signal of the linear encoder 108, an origin sensor signal in the linear stage 109, and an origin sensor signal of the linear stage 112. After the array plate 101 and the light projection unit 104 return to the origin in each axis, the flow proceeds to Step S416.

In Step S416, the CPU 301 reads out Nx×Ny pieces of optical signal data corresponding to each of the wavelengths of the light source from the memory 303, performs data compression processing and format conversion processing, and creates a captured image file in a TIFF format. The captured image file is saved in the memory 303, and is presented to the user via the UI control circuit 314 and the user interface 117. The captured image file can also be transferred to an external data server via the communication circuit 313 in response to an instruction from the user.

In Step S417, the CPU 301 instructs the motor control circuit 308 to move the array plate 101 by Yp in the sub-scanning direction. When a moving amount of the array plate 101 at the time of transmitting one pulse of a voltage pulse signal to the motor driver 111 is represented by My, the number of pulses (pulse count) output from the motor control circuit 308 to the motor driver 111 is Yp/My. In this embodiment, My=2 μm is set. A locus of the light irradiation position during sub-scanning is represented by a locus 505 of FIG. 5B, and a moving distance in the Y direction at that time is Yp. The motor control circuit 308 outputs a pulse signal to the motor driver 111 at a speed at which sub-scanning is completed while the light projection unit 104 is outside a photographing region in the main scanning direction based on an instruction from the CPU 301.

In Step S418, the CPU 301 reads out target heights before and after sub-scanning from the memory 303. That is, Z(Y+Yp) and Z(Y) are read out, and a moving amount of height scanning is calculated. Although the moving amount of the height scanning differs depending on a current Y coordinate, an output pulse count and a rotation direction of a motor are calculated such that a height in a Z direction after movement is closest to a target height Z(Y+Yp) at a Y coordinate after the sub-scanning in Step S417.

A calculation direction is described below. A moving amount of the array plate 101 when one pulse of a voltage pulse signal is transmitted to the motor driver 114 is represented by Mz. In this embodiment, Mz=1 μm is set. Further, a multiple of Mz closest to a certain number “x” is represented by RoundMz(x), an absolute value of the certain number is represented by ABS(x), and a sign of the certain number is represented by Sign(x). Further, a multiple of Mz closest to the target height is referred to as “target pulse count.” The target pulse count takes a discrete value, and corresponds to a pulse count 602 at each spot position of FIG. 6A and FIG. 6B. Here, the number of pulses output from the motor control circuit 309 to the motor driver 114 is represented by Expression 4 below.

Zp=ABS(RoundMz(Z(Y+Yp))−RoundMz(Z(Y))) (Expression 4)

In Expression 4, RoundMz (Z(Y)) is a discrete value close to a surface of the array plate 101 as indicated by the pulse count 602 of FIG. 6A and FIG. 6B.

Further, a tilt direction Dir of the array plate 101 in the height direction is represented by Expression 5 below.

Dir=Sign(RoundMz(Z(Y+Yp))−RoundMz(Z(Y))) (Expression 5)

In Expression 5, a positive direction of Dir is vertically upward, and is a direction in which a distance between the light projection unit 104 and the array plate 101 increases. A value of Dir is 1 when the array plate 101 is tilted as illustrated in FIG. 6A, and a value of Dir is −1 when the array plate 101 is tilted as illustrated in FIG. 6B. After the target height is read out, the flow proceeds to Step S419.

In Step S419, the CPU 301 instructs the motor control circuit 309 to move the array plate 101 by Zp in a direction to cancel the tilt direction Dir. When the value of Dir is positive, the array plate is moved downward, and when the value of Dir is negative, the array plate is moved upward. At this time, a number of pulses output from the motor control circuit 309 to the motor driver 111 is Zp/Mz. The motor control circuit 309 outputs a pulse signal to the motor driver 114 at a speed at which height scanning is completed while the light projection unit 104 is outside the photographing region in the main scanning direction based on an instruction from the CPU 301. After the sub-scanning in Step S417 and the height scanning in Step S419 are completed, the flow proceeds to Step S420.

In Step S420, the synchronization circuit 311 increments a current Y coordinate by Yp from a previous Y coordinate, and the flow proceeds to Step S412.

In Step S421, the light source control circuit 305 switches ON/OFF of light emission of semiconductor lasers of 670 nm and 780 nm based on information of the wavelength switching trigger signal from the synchronization circuit 311. More specifically, when the current main scanning direction is the outward direction (direction in which the X coordinate increases), a laser of 780 nm is caused to emit light when the X coordinate of the light projection unit 104 exceeds the position X3. Further, the light emission of the laser of 780 nm is stopped when the X coordinate exceeds the position X4. When the main scanning direction is the outward direction (direction in which the X coordinate increases), the light emission of the laser of 670 nm is stopped. When the current main scanning direction is the return direction (direction in which the X coordinate decreases), the laser of 670 nm is caused to emit light when the X coordinate of the light projection unit 104 becomes smaller than the position X4. Further, the laser of 670 nm is stopped when the X coordinate becomes smaller than the position X3. When the main scanning direction is the outward direction (direction in which the X coordinate increases), the light emission of the laser of 780 nm is stopped. After the switching of irradiation light is completed, the flow proceeds to Step S412.

With the above-mentioned processing being executed, application of laser beams of two wavelengths to each spot of the array plate 101 and photographing of the spot based on fluorescence caused by the laser beams are completed.

Next, the optical sensor 105 and the receiving circuit 106 in the sample measuring apparatus 1 in this embodiment are described with reference to the drawings. FIG. 7 is a functional block diagram for illustrating details of the optical sensor 105 and the receiving circuit 106 of the sample measuring apparatus 1 according to this embodiment.

The optical sensor 105 used in this embodiment includes photomultiplier tubes 701 and 710 and photodiodes 709 and 711. The photomultiplier tube 701 is excited by light of 780 nm, converts a light amount of fluorescence generated from a sample into an electric current, and outputs the electric current. The photodiode 709 converts a light amount of reflected light of 780 nm reflected by the array plate 101 into an electric current, and outputs the electric current. The photomultiplier tube 710 is excited by light of 670 nm, converts a light amount of fluorescence generated from the sample into an electric current, and outputs the electric current. The photodiode 711 converts a light amount of reflected light of 670 nm reflected by the array plate 101 into an electric current, and outputs the electric current.

The receiving circuit 106 includes the current-voltage conversion (IV) amplifier 702, the level conversion circuit 703, the filter circuit 704, and the AD converter (ADC) 705. The current-voltage conversion amplifier 702 outputs a voltage proportional to an electric current from the photomultiplier tube 701. In this embodiment, an output voltage range of the current-voltage conversion amplifier is from −10 V to 10 V. The level conversion circuit 703 is a circuit that converts a level of an output voltage from the current-voltage conversion amplifier 702 into half, and includes a resistor network and a clamp circuit. A negative voltage is clamped to 0 V by the level conversion circuit, and a positive voltage is converted to ½ of a voltage level by a voltage dividing circuit. In this embodiment, a voltage of a fluorescence signal becomes substantially 0 V or more from a direction of an electric current from the photomultiplier tube 701. Accordingly, with the level conversion circuit 703 being provided, a range in which a value is converted into a digital value by the AD converter 705 in a subsequent stage is limited to a positive voltage, thereby enhancing resolution of the digital value. As a result, an output voltage range after level conversion is from 0 V to 5 V. The filter circuit 704 cuts a high-frequency signal of 500 kHz or more in an output voltage of the level conversion circuit 703. With the filter circuit 704 being provided, aliasing generated during sampling is removed. The AD converter 705 is a 16-bit AD converter that converts the output from the filter circuit 704 into a digital value of from 0 to 65,535.

The AD converter control circuit 306 and the AD converter 705 exchange control signals 706, 707, and 708. The control signal 706 is a conversion start signal for starting sampling and AD conversion. The control signal 707 is a clock signal when optical signal data is transferred from the AD converter 705 to the AD converter control circuit 306. In this embodiment, a clock frequency of the clock signal 707 is 50 MHz. The control signal 708 is a data signal when optical signal data is transferred from the AD converter 705 to the AD converter control circuit 306. The AD converter 705 drives the control signal 708 in synchronization with a clock of the clock signal 707, and outputs optical signal data which is a digital value as an AD conversion result to the AD converter control circuit 306.

Each of the photodiodes 709 and 711 and the photomultiplier tube 710 also outputs optical signal data to the AD converter control circuit 306 by a receiving circuit similar to the photomultiplier tube 701. In the configuration illustrated in FIG. 7, the AD converter control circuit 306 controls a timing of the conversion start signal of each AD converter 705, thereby acquiring respective light amounts of fluorescence and reflected light of 670 nm and fluorescence and reflected light of 780 nm at any timing.

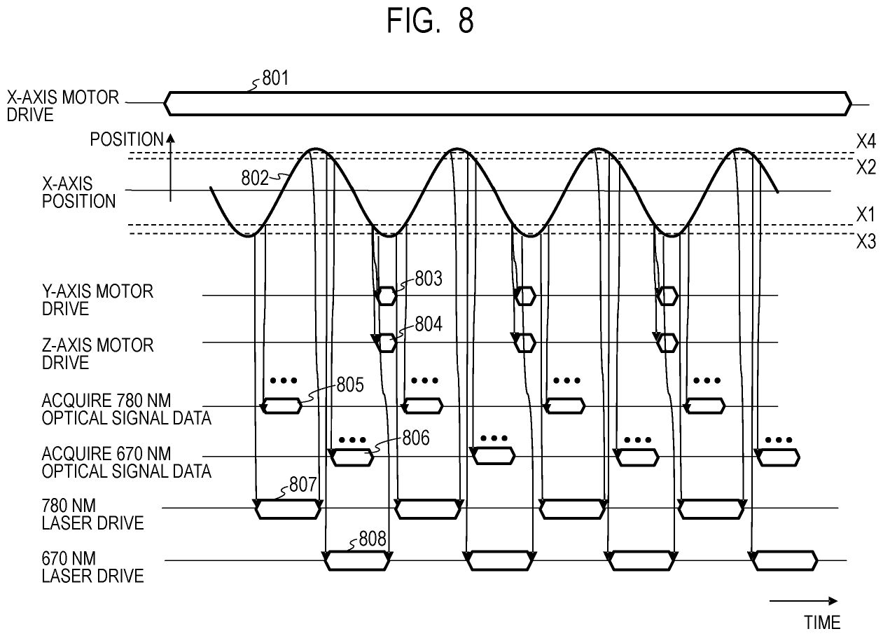

FIG. 8 is a timing chart for illustrating operation timings of main scanning, sub-scanning, height scanning, light irradiation, and optical signal data acquisition in the sample measuring apparatus of this embodiment. The horizontal axis of timing charts therefor represents time. A timing chart 801 indicates an operation timing of main scanning, and indicates that the piston-crank mechanism 120 rotates and the main scanning of the light projection unit 104 is performed at a time indicated by a hexagon. An X-axis position 802 indicates a change in a position of the light projection unit 104 on an X-axis along with time, with the vertical axis corresponding to a position of the light projection unit 104 in the X-axis direction and the horizontal axis corresponding to time. The light projection unit 104 reciprocates by the piston-crank mechanism 120, and it is indicated that the speed is high near a stroke center in the X-axis direction and low in the vicinity of a stroke end in the X-axis direction.

A timing chart 803 indicates an operation timing of sub-scanning. The timing chart 803 indicates that the pulse motor 110 operates at times indicated by hexagons and sub-scanning is performed. A timing chart 804 indicates an operation timing of height scanning. The timing chart 804 indicates that the pulse motor 113 operates at times indicated by hexagons and height scanning is performed. A timing chart 805 indicates an operation timing of optical signal data acquisition at the time of 780 nm excitation light irradiation. The timing chart 805 indicates that the photomultiplier tube 701 and the receiving circuit 106 operate at times indicated by hexagons, and optical signal data derived from excitation light of 780 nm is acquired. A timing chart 806 indicates an operation timing of optical signal data acquisition at the time of 670 nm excitation light irradiation. The timing chart 806 indicates that the photomultiplier tube 701 and the receiving circuit 106 operate at times indicated by hexagons, and optical signal data derived from excitation light of 670 nm is acquired. A timing chart 807 indicates an operation timing of the laser of 780 nm in the light source 102. The timing chart 807 indicates that excitation light of 780 nm is emitted at times indicated by hexagons and applied to the array plate 101 via the light projection unit 104. A timing chart 808 indicates an operation timing of the laser of 670 nm in the light source 102. The timing chart 808 indicates that excitation light of 670 nm is emitted at times indicated by hexagons and applied to the array plate 101 via the light projection unit 104.

As described above, in this embodiment, the array plate 101 is irradiated with excitation light of 780 nm while an X coordinate of the light projection unit 104 moves in the outward direction, and optical signal data generated by the excitation light of 780 nm is acquired. Meanwhile, the array plate 101 is irradiated with excitation light of 670 nm while the X coordinate of the light projection unit 104 moves in the return direction, and optical signal data generated by the excitation light of 670 nm is acquired. By acquiring optical signal data having different excitation wavelengths between the outward direction and the return direction in this manner, an influence of positional misalignment of images between the outward direction and the return direction generated due to a mechanical error of the piston-crank mechanism 120, a delay time of the receiving circuit 106, or the like is reduced.

As illustrated in FIG. 8, when an X coordinate of main scanning acquired by the linear encoder 108 reaches X1 during movement in the outward direction, acquisition of optical signal data based on excitation light of 780 nm is started. Then, when the X coordinate of the main scanning acquired by the linear encoder 108 reaches X2 during movement in the return direction, acquisition of optical signal data based on excitation light of 670 nm is started. When the X coordinate of the main scanning reaches X1 during movement in the return direction, it is determined that acquisition of optical signal data in the return direction is completed, a sub-scanning trigger and a height scanning trigger are output, and sub-scanning and height scanning for moving to the next row are performed.

When the X coordinate of the main scanning acquired by the linear encoder 108 reaches X3 during movement in the outward direction, application of excitation light of 780 nm is started. When the X coordinate of the main scanning reaches X4 during movement in the outward direction, it is determined that acquisition of optical signal data of 780 nm is completed, and application of excitation light of 780 nm is stopped. Further, when the X coordinate of the main scanning acquired by the linear encoder 108 reaches X4 during movement in the return direction, application of excitation light of 670 nm is started. When the X coordinate of the main scanning reaches X3 during movement in the return direction, it is determined that acquisition of optical signal data of 670 nm is completed, and application of excitation light of 670 nm is stopped.

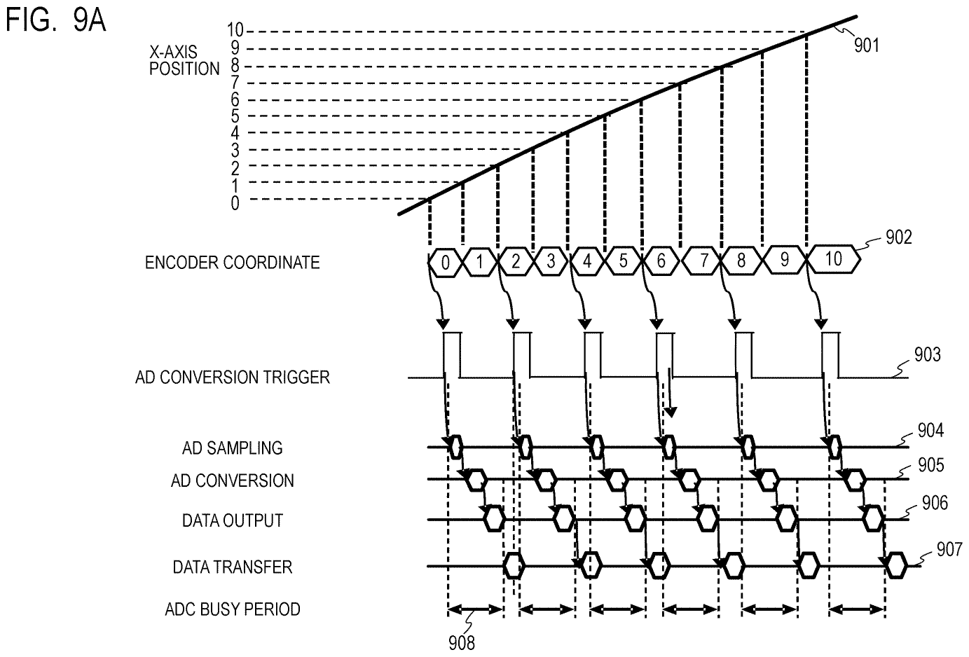

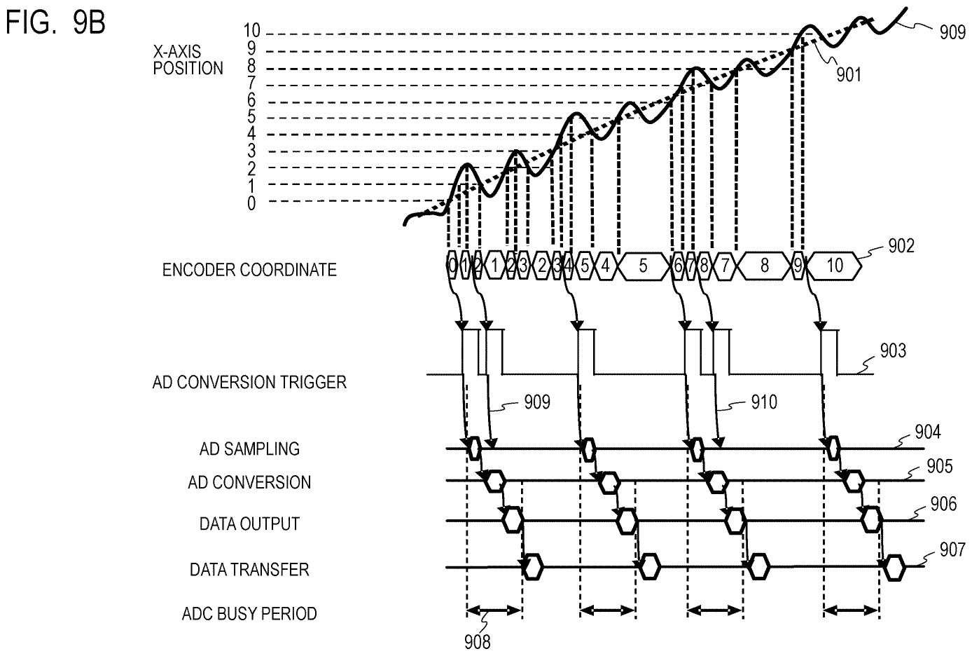

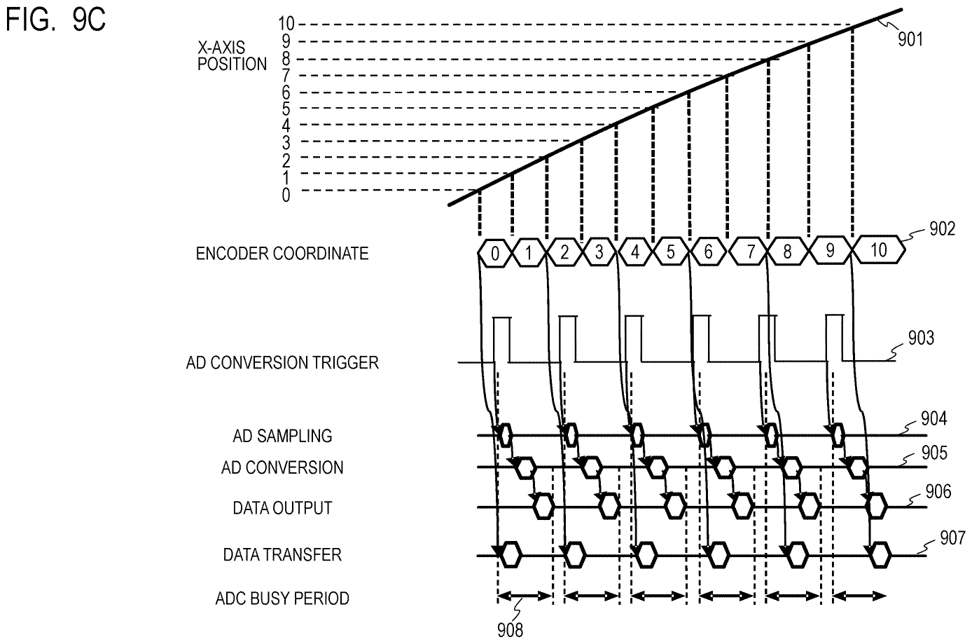

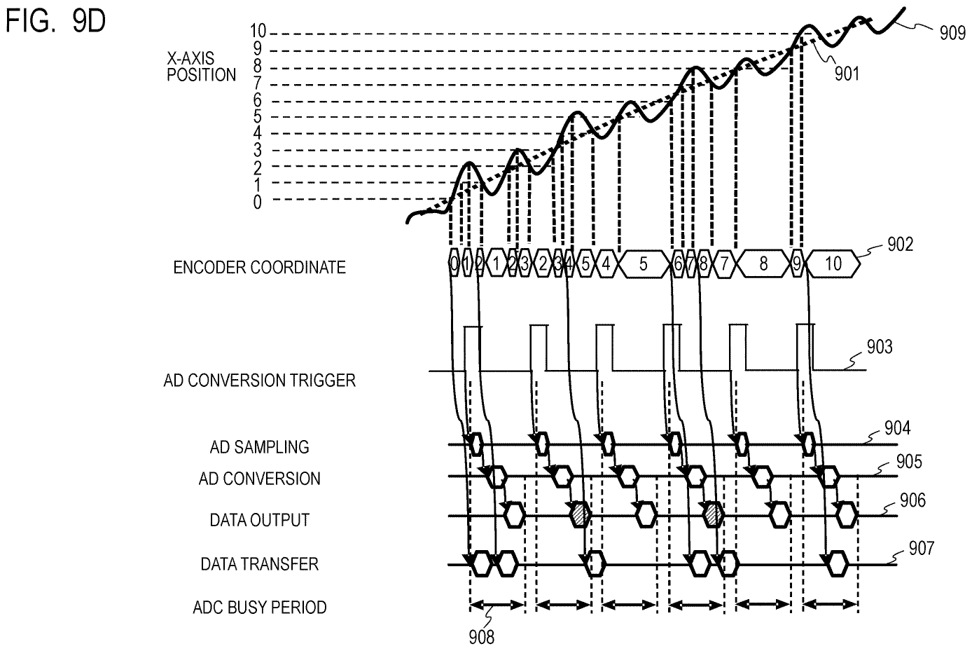

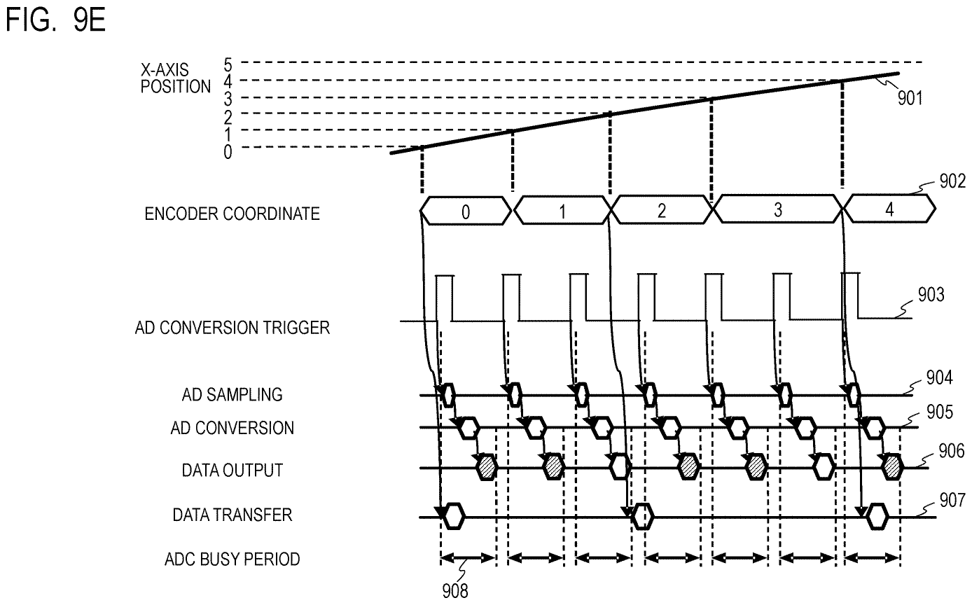

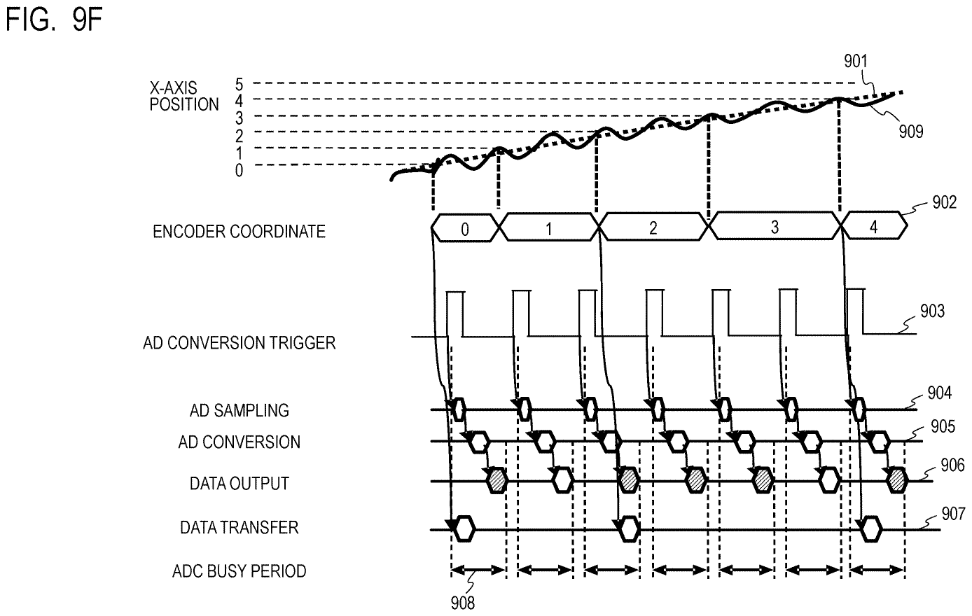

Subsequently, a difference between a control method for the sample measuring apparatus 1 according to the present disclosure and a control method for a sample measuring apparatus in the related art is described with reference to FIG. 9A to FIG. 9F. Here, problems in a case in which sampling of optical signal data is performed in synchronization with simply reaching an X coordinate specified in advance in the main scanning direction as in the related art are first described with reference to FIG. 9A and FIG. 9B.

FIG. 9A shows a timing chart in main scanning executed under ideal conditions in which vibration in the piston-crank mechanism 120 or the like is small. Specifically, FIG. 9A indicates operation timings of the AD converter 705 of the receiving circuit 106, the AD converter control circuit 306, and the data acquisition control circuit 312. In FIG. 9A, a position of the light projection unit in main scanning is represented by an X coordinate 901, and FIG. 9A is an enlarged view near a stroke center of the X-axis position 802 of the light projection unit 104 of FIG. 8. In FIG. 9A, an output signal from the linear encoder 108 is converted into an X coordinate by the coordinate calculation circuit 310, and is shown as a timing chart 902 corresponding to an encoder coordinate. Further, in FIG. 9A, a coordinate at a start point is written as 0 for convenience.

FIG. 9A shows a voltage of a conversion start signal 706 output from the AD converter control circuit 306 to the AD converter 705 of the receiving circuit 106. Here, the conversion start signal 706 rises every time the X coordinate of the light projection unit 104 advances by 2 μm specified by Xp. When a rise of a voltage of the conversion start signal 706 is detected, the AD converter 705 samples a fluorescence signal output from the filter circuit 704. A timing chart 904 shows a signal sampling timing performed inside the AD converter 705. The AD converter 705 operates at times indicated by hexagons in the timing chart 904, and sampling is performed. A fluorescence signal after sampling is held in the AD converter 705, and is converted into a digital value.

A timing chart 905 shows a timing of conversion of the fluorescence signal into a digital value performed inside the AD converter 705. The timing chart 905 indicates that the AD converter 705 operates at times indicated by hexagons, and conversion into a digital value is performed. A timing chart 906 shows a timing at which the AD converter 705 outputs optical signal data to the AD converter control circuit 306. The timing chart 906 indicates that a data signal 708 including an optical signal is transmitted together with a clock signal 707 at times indicated by hexagons, and a digital value is output. The AD converter control circuit 306 sequentially transfers optical signal data acquired from the AD converter 705 to the memory 303. A timing chart 907 shows a timing at which a digital value received by the AD converter control circuit 306 is transferred to the memory 303 via the bus 302. The timing chart 907 indicates that the bus 302 operates at times indicated by hexagons, and a digital value is output.

The AD converter 705 is in operation from start of sampling indicated by the timing chart 904 to completion of output of a digital value indicated by the timing chart 906, and cannot start sampling of the next fluorescence signal. This period is referred to as “busy period of the AD converter.” A timing chart 908 shows the busy period of the AD converter 705. The timing chart 908 indicates that the AD converter 705 is operating during a busy period indicated by an arrow, and sampling cannot be started even when the conversion start signal 706 is input during the period. In this embodiment, a length of the busy period is 800 ns.

As illustrated in FIG. 9A, in an ideal state in which vibration is small during main scanning, a sudden change in an inclination of the X coordinate 901 is small, which indicates that speed variations in main scanning are small. In this case, variations in a timing of the conversion start signal indicated by a change in voltage are small, and a rise thereof is outside the busy period indicated by the timing chart 908. Accordingly, in such a case, acquisition of optical signal data is performed without omission in synchronization with the X coordinate.

However, actually, due to vibration of the piston-crank mechanism 120 or the like, scanning of the light projection unit 104 does not result in a simple positional change. FIG. 9B is a timing chart for illustrating operation timings of the AD converter 705 of the receiving circuit 106, the AD converter control circuit 306, and the data acquisition control circuit 312 when there is such vibration in main scanning. The X coordinate 901 indicated by the dotted line indicates a change in the X coordinate of the main scanning in an ideal case, similarly to the X coordinate 901 of FIG. 9A. The timing charts 902 to 908 are the same as the timing charts 902 to 908 of FIG. 9A, respectively, and thus description thereof is omitted here. A solid line 909 indicates an actual change in the X coordinate of the main scanning when there is vibration, and it is understood that vibration occurs complicatedly with a high frequency in positive and negative directions as compared to the change indicated by the dotted line as the X coordinate 901. In such a case, when viewed globally, main scanning is performed at the same average speed as in FIG. 9A, but when viewed locally, speed variations are large.

Accordingly, variations in coordinate values of the linear encoder indicated by the timing chart 902 are large, and the irradiation position Pi on the X coordinate may advance by 2 μm and pass the next target position Pt at an earlier timing than expected. In that case, as illustrated in FIG. 9B, the conversion start signal indicated by the rise of the voltage in a timing chart 903 rises in the busy period indicated by the timing chart 908. According to an example of FIG. 9C, a timing 910 and a timing 911 in the timing chart 904 are illustrated as examples of a case in which the conversion start signal is transmitted during the busy period. In such a case, a corresponding fluorescence signal cannot be acquired, and the AD converter 705 cannot perform AD conversion. Thus, omission of acquisition of optical signal data occurs.

As described above, in main scanning, speed variations may occur due to vibration or the like. When sampling is performed simply in synchronization with the X coordinate of the main scanning as in the related art, occurrence of the speed variations may lead to omission of acquisition of optical signal data due to the conversion start signal being output during the busy period of the AD converter.

The present disclosure has been made in view of such a situation. Next, an example of an optical signal data acquisition method in the first embodiment is described with reference to FIG. 9C to FIG. 9F.

FIG. 9C is a timing chart for illustrating operation timings of the AD converter 705 of the receiving circuit 106, the AD converter control circuit 306, and the data acquisition control circuit 312 in an ideal case in which vibration of main scanning is small in this embodiment. This embodiment illustrated in FIG. 9C is different from the related art illustrated in FIG. 9A in the following points. Specifically, a voltage rising timing of the conversion start signal 706 indicated by the timing chart 903 and a timing of data transfer from the AD converter control circuit 306 to the memory 303 indicated by hexagons in the timing chart 907 are different. The change in the X coordinate 901 and the timing charts 902, 904, 905, 906, and 908 are the same as those described with reference to FIG. 9A, and hence description thereof is omitted here.

In the timing chart 903, in the example illustrated in FIG. 9A, the voltage rising timing of the conversion start signal is synchronized with the coordinates output from the coordinate calculation circuit 310. In contrast, in this embodiment illustrated in FIG. 9C, the conversion start signal 706 operates such that the voltage rises at a constant frequency regardless of output coordinates from the coordinate calculation circuit 310. Here, a frequency of voltage rise is 1 MHz. A cycle thereof is 1 μs and is longer than 800 ns, which is a length of the busy period, and hence the voltage rise of the conversion start signal 706 is always performed outside the busy period.

In the timing chart 907, in the example of FIG. 9A, optical signal data after AD conversion is sequentially transferred to the memory 303 in accordance with acquisition of the optical signal data from the AD converter 705. In contrast, in the example of FIG. 9C, an operation timing of data transfer to the memory 303 is synchronized with coordinates output from the coordinate calculation circuit 310. That is, at a timing at which the X coordinate advances by 2 μm and reaches the target position Pt, a data acquisition trigger signal is output from the synchronization circuit 311 to the data acquisition control circuit 312. The data acquisition control circuit 312 transfers the latest digital value output to the ADC control circuit by that time to the memory 303. In this way, although AD conversion is performed asynchronously with the X coordinate of the main scanning indicated by the timing chart 902, transfer of the optical signal data is synchronized with the X coordinate. Thus, optical signal data close to an initial target position Pt is transferred to the memory 303.

FIG. 9D is a timing chart for illustrating operation timings of the AD converter 705 of the receiving circuit 106, the AD converter control circuit 306, and the data acquisition control circuit 312 when there is vibration of main scanning in this embodiment. A difference between the example of FIG. 9D and the example of FIG. 9B is a voltage rising timing of the conversion start signal 706 indicated by the timing chart 903 and a timing of data transfer from the AD converter control circuit 306 to the memory 303 indicated by the timing chart 907. The change in the X coordinate 901, the timing charts 902, 904, 905, 906, and 908, and the solid line 909 are the same as those described with reference to FIG. 9B, and hence description thereof is omitted here.

In the timing chart 903, in the example illustrated in FIG. 9B, the driving voltage rising timing of the conversion start signal is synchronized with coordinates output from the coordinate calculation circuit 310. In contrast, in this embodiment illustrated in FIG. 9D, the conversion start signal 706 operates such that the voltage rises at a constant frequency regardless of output coordinates from the coordinate calculation circuit 310. Here, a frequency of voltage rise is 1 MHz. A cycle thereof is 1 μs, and is longer than 800 ns, which is a length of the busy period. Accordingly, even when coordinates of the linear encoder reach the target position Pt within the busy period due to vibration of main scanning, the voltage rise of the conversion start signal is always performed outside the busy period.

In the timing chart 907, in the example of FIG. 9B, the optical signal data after AD conversion is sequentially transferred to the memory 303 in accordance with acquisition of the optical signal data from the AD converter 705. In contrast, in the example of FIG. 9D, the timing of data transfer to the memory 303 is synchronized with coordinates output from the coordinate calculation circuit 310. That is, the data acquisition trigger signal is output from the synchronization circuit 311 to the data acquisition control circuit 312 at a timing at which the X coordinate of the irradiation position Pi of the primary light advances by 2 μm and the irradiation position Pi reaches the target position Pt. The data acquisition control circuit 312 transfers the latest digital value output to the ADC control circuit by that time to the memory 303. As described above, in this embodiment, AD conversion is performed asynchronously with the X coordinate of the main scanning indicated by the timing chart 902, but transfer of optical signal data is synchronized with the X coordinate. With such a configuration, pieces of optical signal data close to equal intervals that are initial target positions Pt are transferred to the memory 303, while preventing omission of acquisition of optical signal data due to passing through the target position Pt within the busy period.

An example in a case in which a scanning speed near a stroke center of the X-axis position 802 of FIG. 8 is high has been described above with reference to FIG. 9A to FIG. 9D. In the following, an example in a case in which a scanning speed near a stroke end of the X-axis position 802 of FIG. 8 is low is described with reference to FIG. 9E and FIG. 9F.

FIG. 9E is a timing chart for illustrating operation timings of the AD converter 705 of the receiving circuit 106, the AD converter control circuit 306, and the data acquisition control circuit 312 when ideal main scanning is performed with a small vibration of the main scanning in this embodiment. In FIG. 9E, the X coordinate 901 indicates a positional change in the main scanning, and is an enlarged view near the stroke end of the X-axis position 802 of FIG. 8. As compared to the example of FIG. 9C, an inclination of the change in the X coordinate 901 is small because the scanning speed is low.

Operations of the timing charts 902 to 908 are the same as those of the example of FIG. 9C. That is, the voltage rise of the conversion start signal 706 operates at a constant frequency regardless of a difference in moving speed of the X coordinate. Here, a frequency of the voltage rise is 1 MHz. A cycle thereof is 1 μs, and is longer than 800 ns, which is a length of the busy period. Thus, the voltage rise of the conversion start signal is always performed outside the busy period.

In the example of FIG. 9E, in the timing chart 907, an operation timing of data transfer to the memory 303 is synchronized with coordinates output from the coordinate calculation circuit 310. That is, the data acquisition trigger signal is output from the synchronization circuit 311 to the data acquisition control circuit 312 at a timing at which the X coordinate of the irradiation position Pi of the primary light advances by 2 μm and the irradiation position Pi reaches the target position Pt. The data acquisition control circuit 312 transfers the latest digital value output to the ADC control circuit by that time to the memory 303. Unlike the example of FIG. 9C, when the scanning speed is low, AD conversion for optical signal data at the next scanning position may be performed before previous optical signal data is transferred to the memory 303. In this case, the data acquisition control circuit 312 overwrites the old optical signal data with new optical signal data, and holds only the latest optical signal data. Pieces of optical signal data acquired at timings indicated by hatched hexagons in the timing chart 906 are overwritten, and hence are not transferred to the memory. As a result, the number of pieces of optical signal data transferred to the memory 303 becomes smaller than the number of pieces of optical signal data to be AD-converted.

In this way, with only the latest optical signal data being transferred to the memory 303 in synchronization with the X coordinate, only the optical signal data in which the irradiation position Pi of primary light is close to the target position Pt is selected and saved in the memory 303. Accordingly, as compared to a case in which AD conversion is simply performed at a constant frequency and acquired optical signal data is sequentially saved in the memory 303, a capacity and a data communication amount of the memory 303 are reduced. Further, in the case in which AD conversion is simply performed at a constant frequency and acquired optical signal data is sequentially saved in the memory 303, large variations occur in acquisition intervals of optical signal data depending on a scanning speed. However, with the method of this embodiment, pieces of optical signal data close to equal intervals are acquired even when the scanning speed changes significantly.

FIG. 9F is a timing chart for illustrating operation timings of the AD converter 705 of the receiving circuit 106, the AD converter control circuit 306, and the data acquisition control circuit 312 when there is vibration of main scanning in this embodiment. The dotted line indicated as the X coordinate 901 is an X coordinate of main scanning in an ideal case, similarly to the X coordinate 901 of FIG. 9E. The timing charts 902 to 908 are the same as the timing charts 902 to 908 of FIG. 9E, respectively, and hence description thereof is omitted here. The solid line 909 indicates an actual change in the X coordinate of the main scanning when there is vibration, and as compared to the change in the X coordinate 901 indicated by the dotted line, it is understood that vibration complicatedly occurs with a high frequency in positive and negative directions. In such a case, when viewed globally, main scanning is performed at the same average speed as in FIG. 9E, but when viewed locally, speed variations are large.

As a result, a timing at which the irradiation position Pi of the primary light passes through the target position Pt shifts in the timing chart 902, and a sequential relationship between the voltage rising timing of the data acquisition trigger signal and the timing of the conversion start signal is different from that in the ideal case illustrated in FIG. 9E. As a result, optical signal data transferred to the memory 303 is different between the exemplary case illustrated in FIG. 9E and the exemplary case illustrated in FIG. 9F. More specifically, when there is no vibration, the third piece of optical signal data from the left in the timing chart 906 of FIG. 9E is transferred to the memory 303. Meanwhile, when there is vibration, the second piece of optical signal data from the left of the timing chart 906 of FIG. 9F is transferred to the memory 303. In this way, even when there is vibration, optical signal data close to the target position Pt can be selectively transferred to the memory, and pieces of optical signal data close to equal intervals are acquired.

Such local vibration changes not only due to position and speed but also due to temporal degradation or the like, and hence it is difficult to predict the local vibration in advance. With the optical signal data acquisition method in this embodiment, pieces of optical signal data close to equal intervals that are initial target positions Pt are acquired while reflecting such a changing situation and preventing omission of acquisition of the optical signal data.

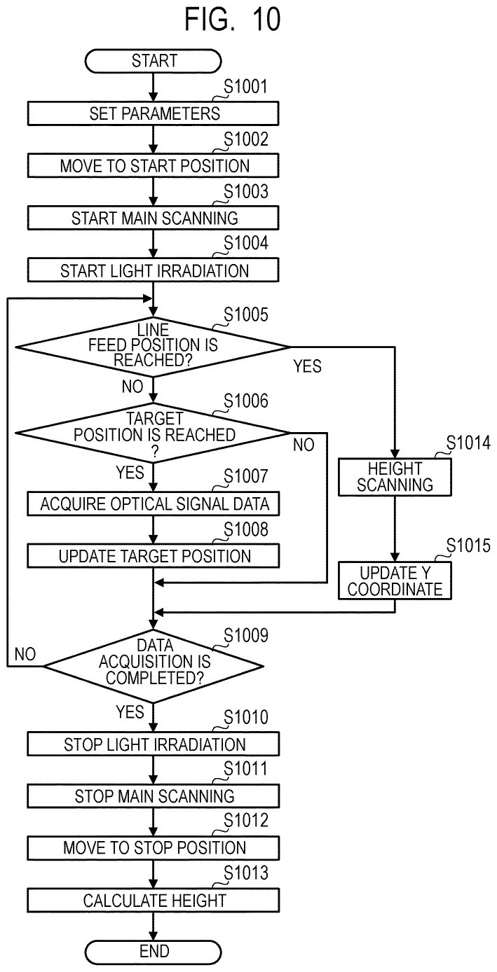

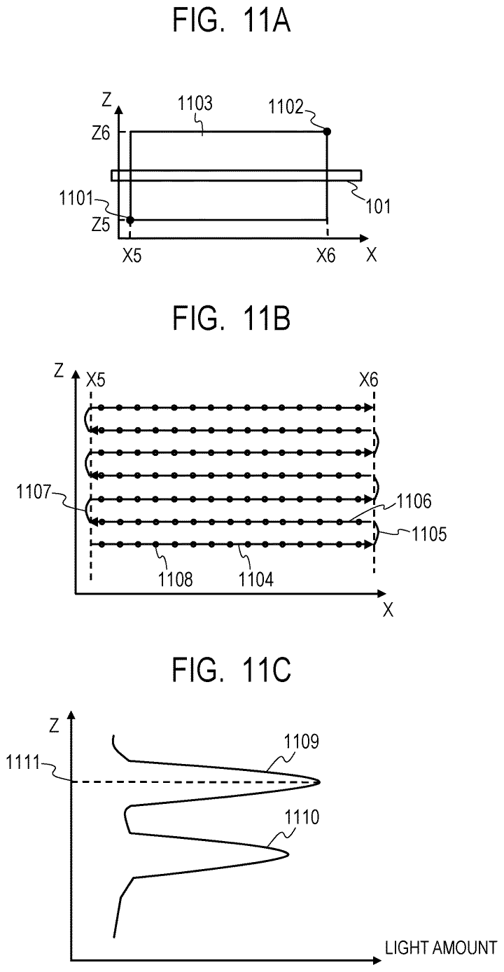

Now, processing of acquiring height information of the array plate 101 in the sample measuring apparatus 1 in this embodiment is described with reference to FIG. 10 and FIG. 11A to FIG. 11C. FIG. 10 shows an operation flow when height information of the array plate 101 is acquired by using the sample measuring apparatus 1 in this embodiment. A point different from the photographing operation is that sub-scanning is not performed at the time of height information acquisition, reflected optical signal data is acquired while height scanning is performed at an equal pitch, the acquired reflected optical signal data is analyzed, and a height of an array plate surface is calculated. In the height information acquisition, the photodiode 709 in the optical sensor 105 is used.

FIG. 11A to FIG. 11C are explanatory diagrams of a positional relationship of height scanning of the array plate in a height information acquisition operation. FIG. 11A and FIG. 11B are diagrams of the array plate 101 as viewed from a side. FIG. 11C is a diagram in which a light amount of reflected light acquired by the optical sensor 105 during height scanning is plotted for each height, in which the horizontal axis indicates a magnitude of a light amount, and the vertical axis indicates an acquired height.

When the height information acquisition processing is started, first, in Step S1001, the CPU 301 sets parameters for acquiring height information in the synchronization circuit 311. The set parameters include a Y coordinate Yh of a position at which height information is to be acquired, a pixel pitch Xp in the main scanning direction, and a pixel pitch Zp in the height scanning direction. In addition, the set parameters include a point 1101 (X5, Z5) and a point 1102 (X6, Z6) indicating a height scanning range on an XZ plane, and a rotational speed Xs in the main scanning direction.

In this embodiment, a rectangular region 1103 having the point 1101 and the point 1102 on the XZ plane as opposite corners is referred to as “height scanning region.” Here, the number Nx of pixels in the main scanning direction (Nx=(X6−X5)/Xp) and the number Nz of pixels in the height scanning direction (Nz (Z6−Z5)/Zp) are calculated in advance. In this embodiment, X5=500, X6=22,500, Z5=2,000, Z6=6,000, Xp=10 [μm], Zp=10 [μm], and Xs=1,200 [rpm] are set. In this case, Nx=2,200 and Nz=400 are obtained. After the parameters are set, the flow proceeds to Step S1002.

In the height information acquisition processing, an acquisition interval of optical signal data may be large, unlike the photographing processing. Accordingly, time required for acquiring height information is shortened and data capacity is reduced. In Step S1002, the CPU 301 instructs the motor control circuits 307, 308, and 309 to move the array plate 101 and the light projection unit 104 to a height information acquisition start position. In this embodiment, an X coordinate of the height information acquisition start position is an end portion of a scanning range of the piston-crank mechanism 120, and an X coordinate value is −2,500. A Y coordinate of the height information acquisition start position is defined as Yh specified by a parameter. Further, a Z coordinate of the height information acquisition start position is defined as Z5 specified by a parameter. After the movement is completed, the flow proceeds to Step S1003.

In Step S1003, the CPU 301 starts main scanning in the same manner as in Step S405 of the photographing processing, and advances the flow to Step S1004. In Step S1004, the CPU 301 causes the light source 102 to start applying excitation light of 760 nm, and advances the flow to Step S1005. In Step S1004, excitation light of 670 nm is not applied.

In Step S1005, the synchronization circuit 311 determines whether or not the light projection unit 104 has reached a line feed position. Specifically, the synchronization circuit 311 determines that the line feed position has been reached when the X coordinate of the light projection unit 104 output from the coordinate calculation circuit 310 shifts from inside the photographing region to outside the photographing region. When a current main scanning direction is the outward direction (direction in which the X coordinate increases), it is determined that the line feed position has been reached when the X coordinate of the light projection unit 104 exceeds X6. Scanning in the outward direction is represented by a locus 1104 of the light projection unit 104 illustrated in FIG. 11B. In addition, when the current main scanning direction is the return direction (direction in which the X coordinate decreases), the synchronization circuit 311 determines that the line feed position has been reached when the X coordinate of the light projection unit 104 becomes smaller than X5. Scanning in the return direction is represented by a locus 1106 of the light projection unit 104 illustrated in FIG. 11B. An initial value of the main scanning direction is the outward direction, and thereafter, the scanning direction is repeatedly changed alternately in the return direction and the outward direction every time a stroke end is reached. Such scanning may be referred to as “Boustrophedon scanning.”

In the height information acquisition processing, unlike the photographing processing, only one type of light irradiation wavelength is required. Accordingly, line feeds can be performed in both of the outward path and the return path, and time required to acquire height information is reduced. When the light projection unit 104 has reached a line feed position, the synchronization circuit 311 outputs a height scanning trigger signal, and the flow proceeds to Step S1014. When the light projection unit 104 has not reached the line feed position, the synchronization circuit 311 does not output a height scanning trigger signal, and the flow proceeds to Step S1006.

In Step S1006, the determination means 173 incorporated in the synchronization circuit 311 determines whether or not the irradiation position Pi has reached the target position Pt, in the same manner as in Step S409 of the photographing processing. The target position Pt is a plurality of points on a locus such as a point 1108 illustrated as an example in FIG. 11B, and is arranged with a pitch in the X direction of Xp and a pitch in the Z direction of Zp. When the synchronization circuit 311 determines that the light projection unit 104 has reached the target position Pt, the synchronization circuit 311 outputs the data acquisition trigger signal, and the flow proceeds to Step S1007. When the synchronization circuit 311 determines that the light projection unit 104 has not reached the target position Pt yet, the synchronization circuit 311 does not output the data acquisition trigger signal, and the flow proceeds to Step S1009.

In Step S1007, the AD converter control circuit 306 and the data acquisition control circuit 312 execute the same processing as Step S410 of the photographing processing to acquire optical signal data, and the flow proceeds to Step S1008. Here, however, the data acquisition control circuit 312 sets the internal data acquisition completion register to 1 after saving Nx×Nz pieces of optical signal data in the memory 303. The data acquisition control circuit 312 sets the internal data acquisition completion register to 0 when the Nx×Nz pieces of optical signal data are not saved in the memory 303. After the optical signal data is acquired, the flow proceeds to Step S1008. In Step S1008, the synchronization circuit 311 updates the target position Pt held internally in the same manner as in Step S411 of the photographing processing, and the flow proceeds to Step S1009.

In Step S1009, the CPU 301 determines whether or not the acquisition of optical signal data is completed in the same manner as in Step S412 of the photographing processing. When the CPU 301 determines that the acquisition of optical signal data is completed, the flow proceeds to Step S1010. When the CPU 301 determines that the acquisition of optical signal data is not completed, the flow proceeds to Step S1005.

In Step S1010, the CPU 301 instructs the light source control circuit 305 to stop light emission of the light source 102 in the same manner as in Step S413 of the photographing processing, and the flow proceeds to Step S1011. In Step S1011, the CPU 301 instructs the motor control circuit 307 to stop rotation of the pulse motor 107 and end the main scanning in the same manner as in Step S414 of the photographing processing, and the flow proceeds to Step S1012. In Step S1012, the CPU 301 instructs the motor control circuits 307, 308, and 309 to move the array plate 101 and the light projection unit 104 to a stop position in the same manner as in Step S415 of the photographing processing, and the flow proceeds to Step S1013.

In Step S1013, the CPU 301 reads out Nx×Nz pieces of optical signal data saved in the memory 303, and analyzes the pieces of optical signal data to calculate height information of the array plate. Specifically, Nx pieces of optical signal data acquired at the same height are subjected to addition and averaging so that an average light amount for each height is obtained. When the obtained average light amounts are arranged for each Z coordinate, two peaks corresponding to a front surface and a back surface of the array plate 101 exist as illustrated in FIG. 11C. More specifically, in FIG. 11C, a peak 1109 indicates a peak due to reflected light from the front surface of the array plate 101, and a peak 1110 indicates a peak due to reflected light from the back surface of the array plate 101. Among those peaks, the peak 1109 having a larger Z coordinate, that is, a Z coordinate 1111 indicating the peak corresponding to the front surface is set as height information corresponding to the position Yh. After the height information is obtained, the height information acquisition processing ends.

In Step S1014, the CPU 301 instructs the motor control circuit 309 to move the array plate 101 by Zp in the height scanning direction. Here, when the moving amount of the array plate 101 at the time of transmitting one pulse of a voltage pulse signal to the motor driver 114 is represented by Mz, the number of pulses output from the motor control circuit 309 to the motor driver 114 is Zp/Mz. Height scanning is represented by a locus 1105 and a locus 1107 of FIG. 11B, and a moving distance in the Z direction is Zp. The motor control circuit 309 outputs a pulse signal to the motor driver 114 at a speed at which height scanning is completed while the light projection unit 104 is outside the photographing region in the main scanning direction based on an instruction from the CPU 301. After scanning in the height direction corresponding to one pulse is completed, the flow proceeds to Step S1015.

In Step S1015, the synchronization circuit 311 increments a current Z coordinate by Zp from the previous Z coordinate, and the flow proceeds to Step S1009. When the tilt information acquisition processing in the photographing processing is executed in Step S402, the height information acquisition processing illustrated in FIG. 10 is performed twice for Y coordinates Y3 and Y4, Z coordinates Z3 and Z4 in each case are obtained, and tilt information K is obtained by using Expression 1.

This embodiment has been described by taking an example in which the photographing region 503 covers the entire region 204 and all spots on the array plate 101 are photographed, but the present disclosure is not limited thereto. That is, it is also possible for a user to set any part of the region 204 as the photographing region 503. This shortens the photographing time by scanning only a part including spots of interest.

This embodiment has been described by taking an example in which height information is acquired by using a peak position of reflected light from a glass slide surface, but the method of acquiring height information is not limited thereto. Height information may be acquired by using a peak position of a luminance of a fluorescence signal from some of the spots on the array plate. In this case, although it is required to irradiate some of the spots with light in order to acquire height information, it is not required to acquire reflected light with an optical sensor, and hence the number of components of the optical system is reduced.

This embodiment has been described by taking an example in which two wavelengths from the light source are switched between the outward path and the return path, but the method of controlling the light source is not limited thereto. Excitation light of two wavelengths may be simultaneously applied in both of the outward path and the return path, and fluorescence derived from each excitation light may be separated and acquired by the optical system. In that case, because two rows are advanced in one round trip, the photographing time is reduced to about half.

As described above, the sample measuring apparatus according to the present disclosure described as the first embodiment optically measures characteristics of a sample by using an array substrate on which spots are provided in an array. The sample measuring apparatus 1 includes light irradiation means, light detection means, scanning means, position acquisition means, conversion means, first holding means, second holding means, determination means, storage means, and transfer means. Further, the present disclosure can also configure a sample measuring method for operating those means as follows. In this embodiment, the light projection unit 104 forms an aspect of the light irradiation means in the present disclosure for irradiating the array substrate (array plate 101) with condensed primary light (excitation light of wavelengths of 670 nm and 780 nm) for a predetermined period. The optical sensor 105 forms an aspect of the light detection means in the present disclosure for detecting secondary light, which is fluorescence from the spot 202 irradiated with the primary light, at a predetermined cycle to output optical signal data as a detection signal. The piston-crank mechanism 120, the linear stage 109, and the motors and the like associated therewith form an aspect of the scanning means in the present disclosure for relatively changing the irradiation position of the primary light with respect to the array substrate. The coordinate calculation circuit 310 forms an aspect of the position acquisition means 138 in the present disclosure for acquiring information on the irradiation position of the primary light with respect to the array substrate.

The receiving circuit 106 including the AD converter 705 and the AD converter control circuit 306 form an aspect of the conversion means 146 in the present disclosure for converting the detection signal acquired in a predetermined period into digital data. The predetermined period described here corresponds to a period defined by encoder coordinates 0 and 1 indicated in the timing chart 902 illustrated as an example in FIG. 9F.

In the present disclosure, the first holding means 171 is included in the synchronization circuit 311 as a buffer memory as illustrated in FIG. 17. That is, the synchronization circuit 311 forms one aspect of the first holding means 171 in the present disclosure for calculating the target position Pt set as a position for acquiring optical signal data regarding the irradiation position of the primary light, and holding the target position Pt in the buffer memory arranged in the synchronization circuit 311. An X coordinate P(N) of an N-th target position Pt is represented by X1+Xp×N(Xp:pitch in the X direction). However, holding the target position Pt is not limited to a case of being executed by the synchronization circuit 311, and the coordinate calculation circuit 310 that calculates the X coordinate of the light projection unit 104 based on the output of the linear encoder 108 may hold the target position Pt. The second holding means 172 is included in the synchronization circuit 311 as a buffer memory as illustrated in FIG. 17, and holds digital data converted by the conversion means 146 illustrated in FIG. 18. The memory 303 forms the storage means in the present disclosure for storing, among digital data pieces held in the second holding means 172, data transferred by the transfer means to be described later in association with information on the irradiation position Pi. Accordingly, the memory 303 may be rephrased as storage means for storing the irradiation position Pi and the digital data in association with each other.

Further, the determination means 173 forms an aspect of the determination means in the present disclosure for determining that the irradiation position Pi of the primary light has reached the target position Pt based on information on the relative position obtained from the linear encoder 108 or the like. The data acquisition control circuit 312 selects digital data corresponding to data output (left two hexagons in the timing chart 906) in a predetermined period in FIG. 9F in accordance with the determination result obtained by the determination means 173 that the irradiation position Pi has reached the target position Pt. The memory control circuit 304 forms an aspect of the transfer means in the present disclosure for transferring the digital data selected in this way to the memory 303. In the present disclosure, the data acquisition control circuit 312 and the memory control circuit 304 are disclosed as separate configurations, but the data acquisition control circuit 312 and the memory control circuit 304 can be treated as an integrated configuration. That is, the data acquisition control circuit 312 is otherwise referred to as transfer means for selecting the digital data held in the second holding means 172 and transferring the selected digital data to the storage means (memory 303) in accordance with the determination result obtained by the determination means 173. The selected digital data is digital data held in the second holding means 172, and is data corresponding to the irradiation position Pi corresponding to the target position Pt.

The sample measuring apparatus 1 may further include the light source 102 and the light source control circuit 305. The light source 102 is optically coupled to the light irradiation means to emit primary light guided to the light projection unit 104. The light source control circuit 305 forms light source control means in this embodiment, and controls ON/OFF of light emission of the light source 102. Further, the light irradiation means in this embodiment includes the objective optical system 129 that condenses primary light onto the array plate 101. The light detection means includes the optical sensor 105 that forms a light detection unit in this embodiment, which is optically coupled to the objective optical system 129 so that secondary light from a spot on the array plate 101 is guided to detect the secondary light. Further, as described above, the scanning means includes the piston-crank mechanism 120, the linear stage 109, motors associated therewith, and the like. In this embodiment, the piston-crank mechanism 120 includes the rotary drive unit 121 and the piston crank unit 123. The rotary drive unit 121 forms an aspect of a rotary drive unit in the present disclosure which is formed of a motor or the like to rotate a drive shaft. The rotary drive unit is connected to one end of the crank 118, which is one end of the piston crank unit 123, and converts a rotational motion of the rotation shaft into a one-dimensional reciprocating motion. The objective optical system 129 (light projection unit 104) is connected to the other end of the connecting rod 119 having one end connected to the other end of the crank 118, which is the other end of the piston crank unit 123. With such a structure, the scanning means can reciprocate the objective optical system (see FIG. 16).

Here, in this embodiment, as indicated by spot positions of FIG. 2A, the target positions Pt are arranged at equal intervals on the array substrate (on the array plate 101). Information on the target position Pt is held in the first holding means 171 as data. Data Itp relating to the target position Pt held in the first holding means 171 is updated in accordance with movement or relative change of the irradiation position by the main scanning means. Further, the conversion means (AD converter 705) converts detected optical signal data into digital data in a predetermined period shorter than a time required for the main scanning means to scan between adjacent target positions Pt with primary light. The transfer means (data acquisition control circuit 312) preferentially selects digital data closer to the end of the predetermined period from among digital data pieces, and transfers the selected digital data to the memory 303. In this embodiment, unhatched hexagonal data, which is second from the left in the timing chart 906 of data output of FIG. 9F (immediately before number 2 in the timing chart 902 of the encoder coordinate), is selected and transferred to the memory 303. Although immediately preceding data is most preferred as a transfer target, immediately preceding two pieces of data, one piece of data immediately preceding the immediately preceding data, or the like may be selected by using a buffer memory or the like, and the selected data may be transferred.

The sample measuring apparatus 1 according to the present disclosure further includes imaging means (image processing unit 301a) for imaging characteristics of a sample based on digital data stored in the storage means (memory 303). The sample measuring apparatus 1 uses the digital data allocated to each pixel (target position Pt) by the image processing unit 301a to image characteristics of a sample, and displays the image on the user interface 117. The sample measuring apparatus 1 according to the present disclosure further includes a buffer memory for temporarily saving converted digital data. In this embodiment, such a buffer memory is provided in the data acquisition control circuit 312. In this buffer memory, when a plurality of converted digital data pieces are obtained within a time required for the irradiation position of the primary light to scan continuous target positions Pt, temporarily stored digital data is overwritten by digital data obtained immediately after the temporarily stored digital data. In the example of FIG. 9F, in the timing chart 906 indicating data output, data indicated by the leftmost hatched hexagon is overwritten by data indicated by the next white hexagon. This processing is executed by the data acquisition control circuit 312.

The present disclosure is also grasped as a control method for a sample measuring apparatus. This control method includes a light irradiation step, a light detection step, a scanning step, a position acquisition step, and a conversion step, and further includes a determination step and a transfer step. Those steps are executed by the controller circuit 116 by using the configuration described above. The light irradiation step is processing continuously executed after Step S406 of FIG. 4, and irradiates an array substrate with condensed primary light for a predetermined period. The light detection step is processing executed in Step S410, and detects secondary light from a spot at a predetermined cycle and outputs a detection signal from the optical sensor 105. The scanning step is processing continuously executed after Step S405, and changes an irradiation position of primary light on an array substrate. The position acquisition step is processing executed together with the scanning step in Step S405, and acquires information on an irradiation position. The conversion step is processing executed in Step S410, and converts the detection signal acquired from the optical sensor 105 at a predetermined cycle into digital data. The determination step is processing executed in Step S409, and determines whether or not the irradiation position Pi corresponds to the target position Pt. The transfer step selects data corresponding to a timing at which the irradiation position Pi has reached the target position Pt from digital data held in the second holding means 172 in accordance with the determination result determined in the determination step, and transfers the selected data to the storage means (memory 303). With those steps being repeatedly executed, digital data can be obtained in a manner in which an image relating to a sample can be generated.

As described above, in the sample measuring apparatus 1 according to this embodiment, AD conversion of a signal from the optical sensor is performed at a constant cycle. Thus, even when the irradiation position Pi passes through the target position Pt during AD conversion due to local speed variations in main scanning or the like, omission of acquisition of optical signal data is prevented, and a fluorescence signal is stably acquired. Meanwhile, transfer of acquired optical signal data to the memory is performed in synchronization with the position of the light projection unit. Thus, even when a driving mechanism having a large change in speed depending on a position, such as the piston-crank mechanism 120, is used, optical signal data acquired at a position close to the target positions Pt at equal intervals is saved in the memory. Further, there is no need to provide a high-speed AD converter for responding to the local speed variations in main scanning, or a robust scanning mechanism for reducing the speed variations. As a result, a large number of fluorescence signals are acquired at short intervals, thereby preventing an increase in cost of the sample measuring apparatus, increasing measurement accuracy, and shortening the photographing time.

### Second Embodiment

A second embodiment of the present disclosure is described below. The second embodiment differs from the first embodiment in that, in acquiring optical signal data, a larger number of pieces of optical signal data than the number of pixels are acquired, and one piece of pixel data is generated from a plurality of acquired pieces of optical signal data. More specifically, in the first embodiment, pixel positions and target positions Pt correspond one-to-one, but there is a possibility that variations in image luminance occur due to influence of random noise of a photomultiplier tube. Accordingly, in this embodiment, a large number of pieces of optical signal data are acquired at intervals smaller than a pixel pitch, and one piece of pixel data is generated by averaging the pieces of optical signal data, thereby reducing an influence of random noise of the photomultiplier tube and improving measurement accuracy and image quality.

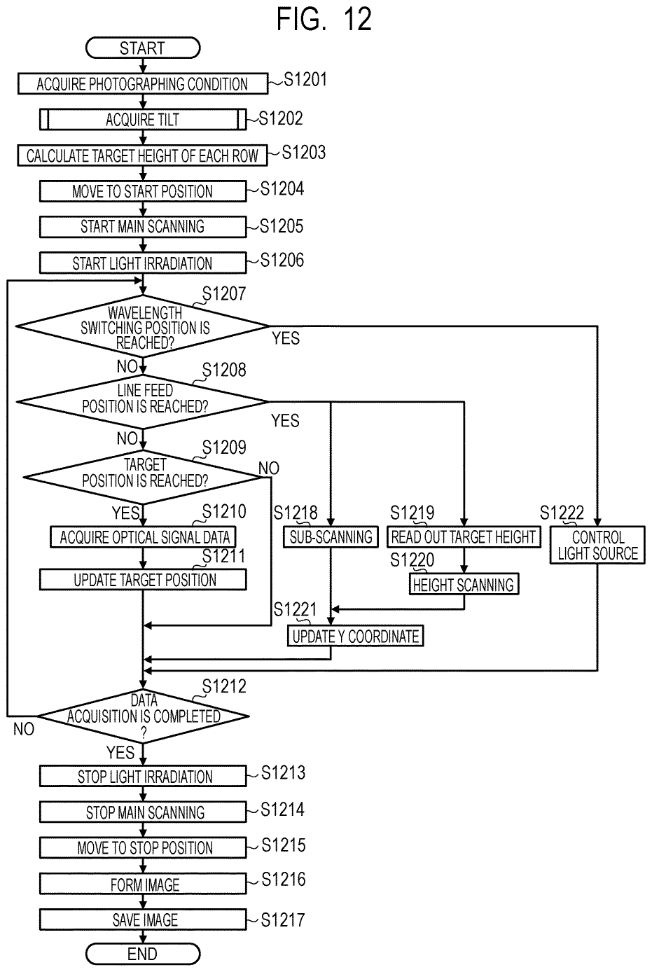

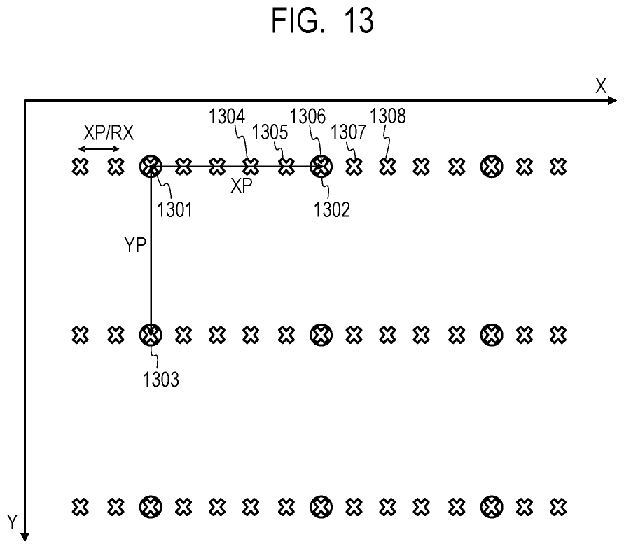

The configuration of the sample measuring apparatus, the configuration of the array plate, and the internal functional configuration of the controller circuit in this embodiment are the same as those illustrated as examples in FIG. 1, FIG. 2A and FIG. 2B, and FIG. 3, respectively. Accordingly, the same reference symbols are used, and description thereof is omitted here. In the following, an operation flow when the array plate is photographed by the sample measuring apparatus of this embodiment is described with reference to FIG. 5A, FIG. 5B, FIG. 6A, FIG. 6B, FIG. 12, and FIG. 13.

FIG. 12 shows an operation flow when the array plate 101 is photographed by the sample measuring apparatus 1 according to this embodiment. When an instruction to start photographing the array plate 101 is input by a user via the user interface 117, processing steps of Step S1201 and subsequent steps are started. In Step S1201, the CPU 301 reads photographing conditions specified by the user via the user interface 117, and saves the read photographing conditions in the memory 303. Further, the CPU 301 sets information that is based on the photographing conditions in various circuits included in the controller circuit 116.

As the photographing conditions, a point 501 (X1, Y1) and a point 502 (X2, Y2) indicating the photographing range on the array plate 101, a pixel pitch Xp in the main scanning direction, a pixel pitch Yp in the sub-scanning direction, and a rotational speed Xs in the main scanning direction are input. In this embodiment, in addition to those, an oversampling rate Rx is further input. The oversampling rate in this embodiment corresponds to the number of pieces of optical signal data (digital data obtained from detection signals) acquired to generate one pixel. When Rx=5 is set, one piece of pixel data is generated from five pieces of optical signal data acquired at an interval of ⅕ of the pixel pitch Xp.

In this embodiment, it is assumed that X1=500, X2=22,500, Y1=500, Y2=64,500, Xp=10 μm, Yp=10 μm, Xs=1,200 rpm, and Rx=5 are input. In this case, a sampling pitch Sx in the main scanning direction is Sx=2 μm. Here, a rectangular region 503 having the point 501 and the point 502 on the array plate 101 as opposite corners is referred to as “photographing region.” Further, the number Nx of pixels in the main scanning direction (Nx=(X2−X1)/Xp), and the number Ny of pixels in the sub-scanning direction (Ny−(Y2−Y1)/Yp) are calculated in advance. In this embodiment, with the above-mentioned settings, Nx=2,200 and Ny=6,400 are obtained. After the above-mentioned settings are completed, the flow proceeds to Step S1202.

Here, processing steps executed in Step S1202 to Step S1208 are the same as the processing steps executed in Step S402 to Step S408 described in the first embodiment, respectively. Accordingly, description of the processing steps executed in those steps is omitted here.

In Step S1209, the synchronization circuit 311 determines whether or not the light projection unit 104 has reached the target position Pt. A point 507 of FIG. 5B indicates a position of a pixel to be imaged on the array plate 101. A target position in this embodiment is a point at which optical signal data is to be acquired on the array plate 101 in order to generate a pixel, and an X coordinate P(N) of an N-th target position Pt is represented by Expression 6 below.

P(N)=X1+(Xp/Rx)×N(N=0,1, . . . Nx×Rx−1) (Expression 6)

The target position is a plurality of points on a locus having a pitch in the X direction of Xp/Rx and a pitch in the Y direction of Yp.

A positional relationship between the target position and the pixel position is now described with reference to FIG. 13. FIG. 13 is a partially enlarged view of FIG. 5B. A point 1301, a point 1302, and a point 1303 indicated by “o” are pixel positions, and are the same as those indicated by the points 507 in FIG. 5B. An interval between the point 1301 and the point 1302 is Xp, and an interval between the point 1301 and the point 1303 is Yp. Further, points 1304 to 1308 indicated by “x” are target positions, and the intervals are evenly arranged at Xp/Rx around a pixel “w”. In this embodiment, this interval is 2 μm. In this embodiment, optical signal data is acquired at five positions from the target positions 1304 to 1308, and the five pieces of data are subjected to addition and averaging so that a luminance value of a pixel 1302 is generated. That is, the number of pieces of initially acquired optical signal data increases by Rx times the number of pixels.

Further, an initial value of the target position Pt is P(0), and is saved in a buffer memory or the like provided inside the synchronization circuit 311. In the first determination of the target position Pt, when the X coordinate of the light projection unit 104 output from the coordinate calculation circuit 310 passes through P(0) in the outward direction (direction in which the X coordinate increases), it is determined that the target position Pt has been reached. In the second and subsequent determinations of the target position Pt, when the X coordinate of the light projection unit 104 output from the coordinate calculation circuit 310 passes through a target position Pt to which the irradiation position Pi is updated in Step S1211 to be described later, it is determined that the target position Pt has been reached.

When the synchronization circuit 311 determines that the target position Pt has been reached, the synchronization circuit 311 outputs the data acquisition trigger signal, and the flow proceeds to Step S1210. When the synchronization circuit 311 determines that the target position Pt has not been reached yet, the synchronization circuit 311 does not output the data acquisition trigger signal, and the flow proceeds to Step S1212.

In Step S1210, the AD converter control circuit 306 outputs the conversion start signal, and the receiving circuit 106 amplifies, filters, and then AD-converts an output voltage from the optical sensor 105. In this embodiment, the conversion start signal is a signal having a constant cycle, and a cycle thereof is longer than a conversion time of the AD converter, but shorter than a time required for the light projection unit 104 to move a distance Xp/Rx. AD-converted optical signal data is temporarily saved in the buffer memory inside the data acquisition circuit 312. The buffer memory can save one piece of optical signal data for one AD converter, and the latest optical signal data is overwritten and saved every time AD conversion is performed. In this embodiment, AD converters corresponding to wavelengths of the light source are provided, and optical signal data reflecting a fluorescence light amount excited by each of the wavelengths of the light source is saved.

When receiving the data acquisition trigger signal, the data acquisition control circuit 312 reads out optical signal data saved in the buffer memory, and outputs the read optical signal data to the memory control circuit 304 via the internal DMA controller and the bus 302. The memory control circuit 304 saves optical signal data at a designated address in the memory 303. The address of the memory 303 is incremented every time the data acquisition trigger signal is received.

The data acquisition control circuit 312 sets the internal data acquisition completion register to 1 after saving Nx×Rx×Ny pieces of optical signal data corresponding to each of the wavelengths of the light source in the memory 303. The data acquisition control circuit 312 sets the internal data acquisition completion register to 0 when Nx×Rx×Ny pieces of data corresponding to each of the wavelengths of the light source are not saved in the memory 303. After the optical signal data at the target position Pt is saved, the flow proceeds to Step S1211.

Processing steps executed in Step S1211 to Step S1215 in this embodiment are the same as the processing steps executed in Step S411 to Step S415 in the first embodiment, respectively. For this reason, description of the processing steps executed in those steps is omitted here.

In Step S1216, the CPU 301 reads out Rx×Nx×Ny pieces of optical signal data corresponding to each of the wavelengths of the light source from the memory 303, and performs image forming processing. In the image forming processing, addition and averaging of Rx pieces of optical signal data in the main scanning direction is performed to generate one piece of pixel data. The pixel data of the point 1302 is generated by performing addition and averaging of five pieces of optical signal data of the points 1304 to 1308, and the pixel data is saved in the memory 303. As a result of the image forming processing, the number of pieces of pixel data corresponding to each of the wavelengths of the light source is Nx×Ny. Optical signal data is divided into a signal component reflecting a fluorescence light amount and a random noise component derived from the optical sensor and the receiving circuit. With addition and averaging being performed, the noise component can be reduced to 1/√Rx while keeping the signal component as it is, which leads to the improvement in S/N. After the CPU 301 performs the image forming processing for each of the wavelengths of the light source, the flow proceeds to Step S1217.

Subsequently, in Step S1217, the CPU 301 reads out Nx×Ny pieces of pixel data corresponding to each of the wavelengths of the light source from the memory 303, performs data compression processing and format conversion processing, and creates a captured image file in a TIFF format. The captured image file is saved in the memory 303, and is presented to the user via the UI control circuit 314 and the user interface 117. Further, the captured image file can be transferred to an external data server via the communication circuit 313 in response to an instruction from the user.

Processing steps executed in Step S1218 to Step S1222 in this embodiment are the same as the processing steps executed in Step S417 to Step S421 in the first embodiment, respectively. Accordingly, description of the processing steps executed in those steps is omitted here.

In this embodiment, oversampling is performed in the main scanning direction, and optical signal data is acquired at intervals smaller than the pixel pitch. However, oversampling is not performed in the sub-scanning direction, and optical signal data is acquired at the same intervals as the pixel pitch. This prevents an increase in photographing time. In this embodiment, an oversampling rate Rx is input from the user via the user interface 117. However, an acquisition method is not limited thereto, and, for example, the oversampling rate Rx may be obtained from the memory 303 based on predetermined conditions. Further, the memory 303 functions as photographing condition holding means in this embodiment for holding the oversampling rate Rx that is input as the photographing condition and corresponds to the number of pieces of digital data acquired to generate one pixel. Further, the user interface 117 functions as an input unit for receiving a command of the oversampling rate Rx from an intervening part in this embodiment. Further, this embodiment has been described by taking an example in which the image forming processing and the averaging processing executed during the processing are performed by causing the image processing unit 301a in the CPU 301 to function as averaging means. Specifically, in this embodiment, the image processing unit 301a serving as the averaging means averages a plurality of pieces of digital data stored in the memory 303, thereby generating pixel data indicating characteristics of a sample. However, an executing subject of image formation or image processing is not limited to this example, and an image forming circuit may be mounted at a subsequent stage of the data acquisition control circuit 312 in an FPGA of the controller circuit 116 to perform the image forming processing by hardware. In that case, the number of pieces of data can be reduced by addition and averaging before the optical signal data is transferred to the memory 303, and effects such as reduction in memory capacity and reduction in photographing time are obtained.

Further, this embodiment has been described by taking an example in which addition and averaging are simply performed in the image forming processing, but a more complicated image forming algorithm may be used. Through use of weighted addition processing, a weight of optical signal data at a point 1306 close to a position of the point 1302 may be increased, and a weight of optical signal data at points 1304 and 1308 far from the position of the point 1302 may be decreased.

As described above, in the photographing processing in this embodiment, the AD conversion is performed at a constant cycle, but the transfer of the acquired optical signal data to the memory is performed in synchronization with the position of the light projection unit. Thus, even when vibration occurs in main scanning, a large number of pieces of optical signal data are stably acquired at small intervals. Further, with those pieces of optical signal data being averaged to generate one piece of pixel data, an influence of noise of the optical sensor and the receiving circuit is reduced, and measurement accuracy is improved and image quality is enhanced.

### Third Embodiment

A third embodiment of the present disclosure is described below. The third embodiment is different from the second embodiment in that a voltage range of optical signal data is adjusted before averaging is performed in the image forming processing, and a value of pixel data is adjusted after the averaging.

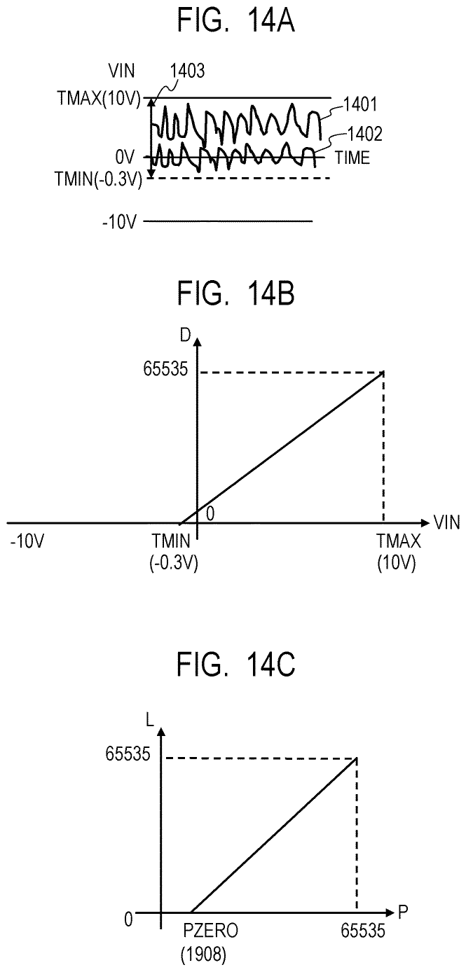

The configuration of the sample measuring apparatus, the configuration of the array plate, and the internal functional configuration of the controller circuit in this embodiment are the same as those illustrated as examples in FIG. 1, FIG. 2A and FIG. 2B, and FIG. 3, respectively. Accordingly, the same reference symbols are used, and description thereof is omitted here. Further, the configurations of the optical sensor 105 and the controller circuit 116 are the same as those described in the first embodiment, and an operation flow when photographing is performed is also similar to that described in the second embodiment. In the following, this embodiment is described with reference to FIG. 7, FIG. 12, and FIG. 14A to FIG. 14C through use of the same reference symbols for the same configurations or processing steps.

FIG. 14A shows a relationship between an output voltage of the current-voltage conversion amplifier 702 (see FIG. 7) and a digital value of output of the AD converter 705 in the third embodiment. In the figure, the horizontal axis represents time, and the vertical axis represents voltage. In FIG. 14A, an output voltage 1401 is an output voltage of the current-voltage conversion amplifier 702 when an amount of light entering the optical sensor 105 is large. When an incident light amount is large, the output voltage 1401 is a positive voltage. Meanwhile, an output voltage 1402 is an output voltage of the current-voltage conversion amplifier 702 when an amount of light entering the optical sensor 105 is minute. The output voltage 1402 is on average around 0 V, but may be a slightly negative voltage due to a voltage offset of the optical sensor and the receiving circuit, or the like. In this case, when only a positive voltage is assigned from 0 to 65,535 and averaged, a negative voltage is clamped to 0, and a voltage after averaging is slightly offset in the positive direction.

Accordingly, in the third embodiment, the level conversion circuit 703 inside the receiving circuit 106 converts a range 1403 indicated by the arrow capable of covering the output voltage 1401 and the output voltage 1402 from 0 V to 5 V. Here, an upper limit value of the range 1403 is represented by Tmax, and a lower limit value thereof is represented by Tmin. Tmax and Tmin are determined in advance. In this embodiment, Tmax=10 V and Tmin=−0.3 V are set. The range of AD conversion is from 0 V to 5 V, and hence a relationship between an input voltage Vin and an output voltage Vout of the level conversion circuit 703 is a relationship represented by Expression 7 below.

Vout=5×(Vin−Tmin)/(Tmax−Tmin) (Expression 7)

In this embodiment, input and output are set to amounts with which a resistance value of a resistor network of the level conversion circuit 703 satisfies the condition shown in Expression 7. Further, a digital value D output from the AD converter 705 has a relationship shown in Expression 8 below.

D=(Vout/5)×65,535=(Vin−Tmin)/(Tmax−Tmin)×65,535 (Expression 8)

FIG. 14B is a diagram for illustrating an input/output relationship from voltage level conversion inside the receiving circuit 106 to the AD converter. In the figure, the horizontal axis represents the input voltage Vin of the level conversion circuit, and the vertical axis represents the digital value after the AD conversion. In the receiving circuit 106 in this embodiment, level conversion and AD conversion are performed such that −0.3 V becomes 0 of the digital value and 10 V becomes 65,535 of the digital value. With such level conversion being provided, a signal whose output voltage is less than 0 V due to an offset voltage of the optical sensor 105 and the receiving circuit 106 when a light amount is minute is also acquired without omission.

However, when the averaged pixel data is imaged as it is, even when an average value is 0 V, the digital value becomes a large value by an amount offset by 0.3 V. For this reason, the luminance increases by that amount even in an area in which there is no signal, and an area without the spot 202 of the array plate 101 also becomes bright in the captured image. A point in which the photographing processing in this embodiment is different from the photographing processing in the second embodiment is that, in the image forming processing of Step S1216 of FIG. 12, after averaging is performed and pixel data of the target position Pt is calculated, level conversion is performed again on each piece of pixel data to adjust output pixel data. Processing steps other than Step S1216 of FIG. 12 are the same as the processing steps executed in the respective steps in the second embodiment, and hence description thereof is omitted here.

Here, in the image forming processing of Step S1216, pixel data after level conversion is represented by L. When pixel data when an average value of the voltage Vin is 0 V is represented by Pzero, Pzero=−Tmin/(Tmax−Tmin)×65,535 is obtained. In this embodiment, Tmax=10 V and Tmin=−0.3 V are set, and hence Pzero=1,908 is obtained. FIG. 14C is a diagram for illustrating an input/output relationship of pixel level conversion in the image forming processing. In the figure, the horizontal axis represents the pixel data of the target position Pt after the averaging, and the vertical axis represents the output pixel data L after the pixel level conversion. In the image forming processing in this embodiment, linear conversion is performed such that the output pixel data Lis L=0 when Pt Pzero is satisfied, and L=65,535 when Pt=65,535 is satisfied. That is, when Pt is Pzero or more, the relationship between L and Pt satisfies a relationship shown in Expression 9 below.

L=65,535/(65,535−Pzero)×(Pt−Pzero) (Expression 9)

When Pt is less than Pzero, L is 0. Then, the output pixel data is saved in the memory 303, and the flow proceeds to Step S1217.

This embodiment has been described by taking an example in which the maximum value is the same before and after the conversion in the pixel level conversion. However, when a maximum value of the pixel data after averaging becomes smaller than 65,535 due to saturation of the receiving circuit or the like, the maximum value may also be converted in the image forming processing. Further, when the maximum value of the pixel data after the averaging is limited to 62,000 due to saturation inside the receiving circuit or the like, a range of from 1,908 to 62,000 of the pixel data of the target position Pt after the averaging may be assigned to 0 to 65,535 of the output pixel data L.

That is, in this embodiment, the image processing unit 301a serving as averaging means averages the digital data converted from the detection signal in a first range including positive and negative detection signals, which is illustrated as an example in the range 1403 of FIG. 14A, by the AD converter control circuit 306. Then, the image processing unit 301a performs level conversion of assigning a partial range of the first range to a pixel value for the averaged data.

Also regarding pixel level conversion processing in this embodiment, similarly to the averaging processing executed in the second embodiment, an image forming circuit may be mounted at a subsequent stage of the data acquisition control circuit 312 in the FPGA of the controller circuit 116 to perform the processing by hardware. In that case, effects such as reduction in amount of data transfer to the memory 303 and reduction in photographing time are obtained.

As described above, in the photographing processing according to this embodiment, when oversampling is performed, a range for AD conversion of an optical signal is expanded to acquire a negative value near 0 V as well. This prevents a phenomenon in which an average value of optical signal data is offset in a positive direction when an amount of light entering the optical sensor 105 is minute. Further, with conversion of a pixel level being performed again after averaging, a region having no signal in a captured image is prevented from becoming bright.

### Fourth Embodiment

A fourth embodiment of the present disclosure is described below. The fourth embodiment is different from the first embodiment in that the target position Pt is shifted between the outward path and the return path so that a deviation between a predetermined target position and a position at which optical signal data saved in the memory is actually sampled decreases.

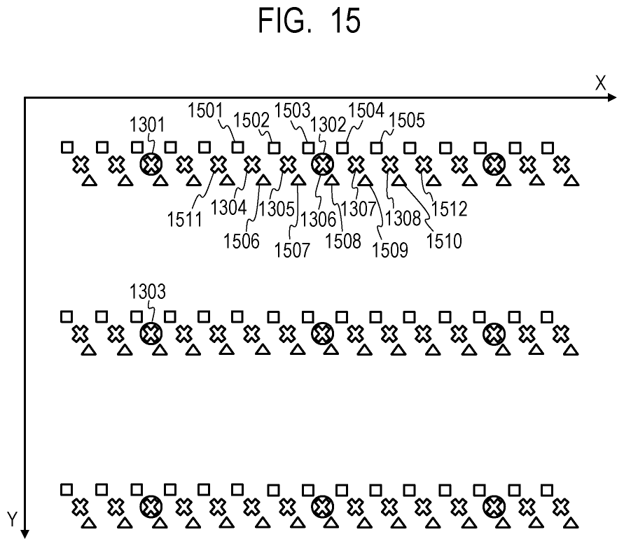

The configuration of the array plate and the internal functional configuration of the controller circuit of the sample measuring apparatus in this embodiment are the same as those illustrated as examples in FIG. 1, FIG. 2A and FIG. 2B, and FIG. 3, respectively. Accordingly, the same reference symbols are used, and description thereof is omitted here. Further, the configurations of the optical sensor 105 and the controller circuit 116 are the same as those described in the first embodiment, and an operation flow when photographing is performed is also the same as that described in the first embodiment. In the following, this embodiment is described with reference to FIG. 1, FIG. 7, FIG. 9F, FIG. 15, and FIG. 16 through use of the same reference symbols for the same configurations or processing steps.

In FIG. 9F, a trigger cycle of AD conversion in the timing chart 903 is represented by Ta, and a delay time until data transfer is performed after the linear encoder 108 detects that the light projection unit 104 actually passes a certain X coordinate is represented as Td1. Further, a delay time from when the AD converter 705 performs sampling as indicated by the timing chart 904 until optical signal data is output as indicated by the timing chart 906 is represented by Td2. In addition, a moving speed of the light projection unit 104 is represented by Vx. In this case, Vx is an inclination of a dotted line indicated as the X coordinate 901.

The optical signal data in the timing chart 907 transferred to the memory is optical signal data that has been sampled and AD-converted before the irradiation position Pi passes through the target position Pt. The second piece of optical signal data from the left in FIG. 9F is transferred when the coordinate of the light projection unit 104 is 2, but is actually sampled when the encoder coordinate is 1.

A difference “dt” between a time when the irradiation position Pi passes through the target position Pt and a time when the optical signal data saved in the memory is sampled becomes a time between (Td2−Td1) and (Td2−Td1+Ta) in consideration of a delay time. In addition, a deviation between the predetermined target position and a position at which the optical signal data saved in the memory is actually sampled ideally becomes “dt” multiplied by Vx, and takes a value between (Td2−Td1)×Vx and (Td2−Td1+Ta)×Vx.

Td1 is a constant value determined by the linear encoder 108, the coordinate calculation circuit 310, the synchronization circuit 311, and the data acquisition control circuit 312, and is 250 ns in this embodiment. Td2 is a constant value determined by the receiving circuit 106 and the AD converter control circuit 306, and is 800 ns in this embodiment. Further, when a frequency of the AD converter 705 is 1 MHz, Ta is 1 μs. Vx is a value that changes between 0 m/s and 2 m/s depending on a rotation angle of the piston-crank mechanism 120. When limited to an inside of the photographing region 503, Vx changes between 1 m/s and 2 m/s. In this case, a deviation of the target position Pt in the outward path is from 0.55 μm to 1.55 μm when Vx is near 1 m/s, but becomes as large as about 1.1 μm to about 3.1 μm when Vx is near 2 m/s. The deviation has a range because sampling and a position of the light projection unit 104 are asynchronous, and the deviation changes depending on at which timing in the cycle Ta the irradiation position Pi passes through the target position Pt. For the return path, an amount of positional deviation is the same, and a direction of the deviation is reversed. Accordingly, in this embodiment, with the target position Pt being shifted, (Td2−Td1)×Vx, which is a fixed portion of the positional deviation, is corrected.

FIG. 15 is a diagram for illustrating the target position Pt in this embodiment. Points 1301, 1302, and 1303 of FIG. 15 are positions of pixels, and are the same as the pixel positions of the second embodiment described with reference to FIG. 13. Points 1304 to 1308 indicated by “x” are points evenly arranged at Xp/Rm intervals around a pixel, and are the same as the target positions described with reference to FIG. 13. Further, a point 1511 indicated by “x” is a point obtained by shifting the point 1304 by Xp/Rm in the return direction, and a point 1512 is a point obtained by shifting the point 1308 by Xp/Rm in the outward direction.

In FIG. 15, points indicated by “□” are target positions when the light projection unit 104 is moving in the outward direction, and are target positions for acquiring fluorescence signal data for excitation light of 760 nm. When a pixel of a captured image is generated based on the excitation light of 760 nm at the point 1302, addition and averaging of optical signal data sampled at five positions of points 1501 to 1505 are performed, and the obtained value is used. Points indicated by “A” are target positions when the light projection unit 104 is moving in the return direction, and are target positions for acquiring fluorescence signal data for excitation light of 670 nm. When a pixel of a captured image is generated based on the excitation light of 670 nm at the point 1302, addition and averaging of optical signal data sampled at five positions of points 1506 to 1510 are performed, and the obtained value is used.

Points indicated by “□”, “x”, and “Δ” are drawn to be shifted in the Y-axis direction for easy viewing of the drawing, but Y coordinates of the three are actually the same. The target positions indicated by “□” are positions shifted by (Td2−Td1)×Vx in the return direction from the positions indicated by “x”. Similarly, the target positions indicated by “Δ” are positions shifted by (Td2−Td1)×Vx in the outward direction from the positions indicated by “x”. That is, in this embodiment, the target position is set so as to be shifted between the outward path and the return path in accordance with a delay time generated at the time of conversion into digital data by the AD converter control circuit 306. Thus, positional deviation derived from a delay time generated in the receiving circuit 106 and the controller circuit 116 is corrected by generating a data acquisition trigger earlier than when a position desired to be acquired is actually passed.

In this embodiment, an amount of positional deviation is obtained as follows. Referring to FIG. 16, which is an enlarged diagram of a periphery of the piston-crank mechanism 120 illustrated in FIG. 1, a position “x” of the light projection unit 104 is represented by Expression 10 below by using a length “r” of the crank 118, a length “1” of the connecting rod 119, and an angle θ of the pulse motor 107.

x=r cos θ+l²−r² sin²θ (Expression 10)

Further, a velocity Vx is represented by Expression 11 below by differentiating Expression 10.

$$Vx = - r sin θ - \frac{{r}^{2} sin 2 θ}{\sqrt{{l}^{2} - {r}^{2} {sin}^{2} θ}} \qquad ( Expression 11 )$$

θ is calculated by multiplying a rotation angle per pulse by the number of drive pulses. Further, “r” and “1” are known values, and hence a velocity of the light projection unit 104 is calculated by using Expression 11 for each drive pulse, and is multiplied by a delay time of Td2−Td1, thereby obtaining in advance a positional deviation amount for each X coordinate in the outward path and the return path. The obtained positional deviation amount is saved in the synchronization circuit 311. However, the rotation angle per pulse is in increments of 0.72°, and hence obtained values of “x” also become discrete. Accordingly, in this embodiment, the coordinate calculation circuit 310 interpolates and estimates coordinates between pulses by using an angular velocity.

As described above, in the photographing processing in this embodiment, the target position Pt is shifted between the outward path and the return path in advance in consideration of a velocity of the piston-crank mechanism 120 and delay times of the linear encoder 108, the receiving circuit 106, and the controller circuit 116. In this manner, positional deviation between a predetermined target position and a position at which optical signal data saved in the memory is actually sampled can be reduced, thereby enabling highly accurate optical signal data acquisition.

This embodiment has been described by taking an example in which optical signal data is acquired by shifting positions at a sampling stage, but positional deviation between the outward path and the return path may be corrected by another method. The target position is the same for the outward path and the return path as indicated by “x” of FIG. 15, but optical signal data used when a pixel in the outward path is generated and optical signal data used when a pixel in the return path is generated may be shifted in the image forming processing. When pixel data of the point 1304 is generated, in the outward path, five pieces of optical signal data of the point 1511 and the points 1304 to 1307 may be averaged, and in the return path, five pieces of optical signal data of the points 1305 to 1308 and the point 1512 may be averaged. In this method, an effect of correcting the positional deviation is limited by an acquisition interval Xp/Rm of the optical signal data, but the positional deviation between the outward path and the return path is corrected by a simple method.

### OTHER EMBODIMENTS

The present disclosure may also be achieved by processing in which software (a program) for achieving one or more functions of the various embodiments described above is supplied to a system or an apparatus through a network or a storage medium, and a computer of the system or the apparatus reads out and executes the program. The computer includes one or a plurality of processors or circuits, and in order to read out and execute executable instructions on the computer, may include a network of a plurality of separate computers or a plurality of separate processors or circuits.

In this case, the processors or circuits may include a central processing unit (CPU), a microprocessing unit (MPU), or a graphics processing unit (GPU). The processors or circuits may also include an application-specific integrated circuit (ASIC), or a field-programmable gateway (FPGA). The processors or circuits may also include a digital signal processor (DSP), a data flow processor (DFP), or a neural processing unit (NPU).

As described above, with the sample measuring apparatus according to the present disclosure, an optical signal is stably acquired even when variations in scanning speed occur while the cost is low. As a result, a large number of optical signals are acquired at short intervals. As a result, higher accuracy of measurement and reduction in photographing time are achieved while an increase in cost of the apparatus is prevented.

According to one aspect of the present disclosure, the sample measuring apparatus and the control method for a sample measuring apparatus with which optical signal data can be stably acquired with a simple configuration even when variations in a scanning speed occur are provided

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A sample measuring apparatus for optically measuring characteristics of a sample by using an array substrate on which spots are provided in an array, the sample measuring apparatus comprising:
light irradiation means for irradiating the array substrate with condensed primary light for a predetermined period;
light detection means for detecting secondary light from each of the spots at a predetermined cycle to output a detection signal;
scanning means for changing an irradiation position of the primary light with respect to the array substrate;
position acquisition means for acquiring information on the irradiation position;
conversion means for converting the detection signal detected at the predetermined cycle into digital data;
first holding means for holding information on a target position Pt relating to the irradiation position;
second holding means for holding the digital data;
determination means for determining whether the irradiation position corresponds to the target position Pt;
storage means for storing the digital data; and
transfer means for selecting data corresponding to a timing at which the irradiation position has reached the target position Pt from the digital data held in the second holding means in accordance with a determination result obtained by the determination means, and transferring the selected data to the storage means.

2. The sample measuring apparatus according to claim 1, further comprising photographing condition holding means for holding, as a photographing condition, an oversampling rate corresponding to the number of pieces of the digital data acquired to generate one pixel.

3. The sample measuring apparatus according to claim 2, further comprising an input unit configured to receive a command of the oversampling rate from an outside.

4. The sample measuring apparatus according to claim 1, further comprising:
a light source optically coupled to the light irradiation means; and
light source control means for controlling ON/OFF of light emission of the light source.

5. The sample measuring apparatus according to claim 1,
wherein the light irradiation means includes an objective optical system configured to condense the primary light onto the array substrate, and
wherein the light detection means includes a light detection unit which is optically coupled to the objective optical system and to which the secondary light is to be guided.

6. The sample measuring apparatus according to claim 5, wherein the scanning means includes:
a rotary drive unit; and
a piston-crank unit configured to convert a rotational motion of the rotary drive unit into a one-dimensional reciprocating motion to reciprocate the objective optical system.

7. The sample measuring apparatus according to claim 1, wherein the target positions Pt are arranged at equal intervals on the array substrate.

8. The sample measuring apparatus according to claim 1, wherein the target position Pt held in the first holding means is updated based on movement of the irradiation position or the changing of the irradiation position.

9. The sample measuring apparatus according to claim 1, wherein the conversion means is configured to convert the detection signal into the digital data in a period shorter than a time required for the primary light to scan between the adjacent target positions Pt.

10. The sample measuring apparatus according to claim 1, wherein the transfer means is configured to preferentially select digital data closer to an end of the predetermined period from the digital data, and transfer the selected digital data to the storage means.

11. The sample measuring apparatus according to claim 1, further comprising imaging means for imaging the characteristics of the sample based on the digital data stored in the storage means.

12. The sample measuring apparatus according to claim 1, further comprising averaging means for averaging a plurality of pieces of digital data stored in the storage means to generate pixel data indicating the characteristics of the sample.

13. The sample measuring apparatus according to claim 12, wherein the averaging means is configured to perform level conversion of assigning, for data obtained after averaging the digital data converted by the conversion means from the detection signal in a first range including a positive detection signal and a negative detection signal, a partial range of the first range to a pixel value.

14. The sample measuring apparatus according to claim 1,
wherein the scanning means is configured to reciprocate and scan the irradiation position of the primary light on the array substrate, and
wherein the target position Pt is set to be shifted between an outward path and a return path in accordance with a delay time generated at a time of conversion into the digital data by the conversion means.

15. The sample measuring apparatus according to claim 1, further comprising a buffer memory configured to temporarily save the converted digital data,
wherein, in the buffer memory, when a plurality of pieces of converted digital data are obtained within a time required for the irradiation position of the primary light to scan continuous target positions Pt, temporarily saved digital data is overwritten by digital data obtained immediately after the temporarily saved digital data.

16. A control method for a sample measuring apparatus including: first holding means for holding a target position relating to an irradiation position of primary light in order to optically measure characteristics of a sample by using an array substrate on which spots are provided in an array; second holding means for holding, as digital data, a detection signal detected by measurement of secondary light from each of the spots; and
storage means for storing the irradiation position and the digital data in association with each other, the control method comprising:
a light irradiation step of irradiating the array substrate with condensed primary light for a predetermined period;
a light detection step of detecting the secondary light from each of the spots at a predetermined cycle to output a detection signal;
a scanning step of changing the irradiation position of the primary light with respect to the array substrate;
a position acquisition step of acquiring information on the irradiation position;
a conversion step of converting the detection signal acquired at the predetermined cycle into the digital data;
a determination step of determining whether the irradiation position corresponds to a target position Pt; and
a transfer step of selecting data corresponding to a timing at which the irradiation position has reached the target position Pt from the digital data held in the second holding means in accordance with a determination result determined in the determination step, and transferring the selected data to the storage means.

17. A medium for storing program for causing a computer to execute each step of the control method for a sample measuring apparatus of claim 16.
